(19) United States
(12) Patent Application Publication
(10) Pub. No.: US 2024/0185511 A1
(43) Pub. Date: Jun. 6, 2024

(54) INFORMATION PROCESSING APPARATUS AND INFORMATION PROCESSING METHOD

(71) Applicant: SONY GROUP CORPORATION, TOKYO (JP)

(72) Inventors: TAKUMI TSURU, TOKYO (JP); TOSHIYA HAMADA, TOKYO (JP)

(21) Appl. No.: 18/554,295

(22) PCT Filed: Apr. 19, 2022
(86) PCT No.: PCT/JP2022/018203

§ 371 Date: Oct. 6, 2023

(30) Foreign Application Priority Data
Apr. 21, 2021 (JP) 2021-072142

(51) Int. Cl. G06T 15/20; G06F 3/01; G06T 13/20

(52) U.S. Cl. CPC G06T 15/20; G06F 3/012; G06F 3/013; G06T 13/20; G06T 2210/32

(57) ABSTRACT

An information processing apparatus according to an embodiment of the present technology includes a rendering unit and a generation unit. The rendering unit performs rendering processing on three-dimensional space data on the basis of field-of-view information regarding a field of view of a user, to generate two-dimensional video data corresponding to the field of view of the user. The generation unit generates a saliency map representing a saliency of the two-dimensional video data on the basis of a parameter regarding the rendering processing. This makes it possible to achieve distribution of a high-quality virtual video.

### TECHNICAL FIELD

The present technology relates to an information processing apparatus and an information processing method that are applicable to, for example, distribution of virtual reality (VR) videos.

### BACKGROUND ART

In recent years, an omnidirectional video that is captured by an omnidirectional camera or the like and can provide views in all directions has been distributed as a VR video. More recently, a technique of distributing a 6 degrees of freedom (DoF) video (also referred to as 6 DoF content), in which a viewer (user) can view all directions (freely select a line-of-sight direction) and freely move in a three-dimensional space (freely select a viewpoint position), is being developed.

Such 6 DoF content dynamically reproduces a three-dimensional space by using one or a plurality of three-dimensional objects in accordance with a viewpoint position, a line-of-sight direction, and a field-of-view angle (field-of-view range) of a viewer at each time.

In such video distribution, it is required to dynamically adjust (render) video data to be presented to the viewer in accordance with the field-of-view range of the viewer. For example, examples of such a technique include the technique disclosed in Patent Literature 1.

Further, Non-Patent Literature 1 describes the research on a saliency map model for performing line-of-sight movement prediction.

In this research, a depth detection mechanism is implemented in the saliency map calculation process in the saliency map model. A line-of-sight movement prediction model on a two-dimensional image in a conventional model is then extended to a model for line-of-sight movement prediction on a three-dimensional space. As a result of a simulation experiment, a feature of object selection in the three-dimensional space is matched with measured data to some extent.

### CITATION LIST

### Patent Literature

Patent Literature 1: Japanese Unexamined Patent Application Publication No. 2007-520925

### Non-Patent Literature

Non-Patent Literature 1: GOCHI Taiki, KOHAMA Takeshi, “Saliency map model for visual attention in depth”, Journal of The Institute of Image Information and Television Engineers, Vol. 35, No. 16, pp. 31-34, March 2011

### DISCLOSURE OF INVENTION

### Technical Problem

Distribution of virtual videos such as VR videos is expected to become widespread, and there is a demand for a technique capable of distributing high-quality virtual videos.

In view of the circumstances as described above, it is an object of the present technology to provide an information processing apparatus and an information processing method that are capable of achieving distribution of a high-quality virtual video.

### Solution to Problem

In order to achieve the above object, an information processing apparatus according to an embodiment of the present technology includes a rendering unit and a generation unit.

The rendering unit performs rendering processing on three-dimensional space data on the basis of field-of-view information regarding a field of view of a user, to generate two-dimensional video data corresponding to the field of view of the user.

The generation unit generates a saliency map representing a saliency of the two-dimensional video data on the basis of a parameter regarding the rendering processing.

In such an information processing apparatus, the saliency map that represents the saliency of the two-dimensional video data is generated on the basis of the parameter regarding the rendering processing for generating the two-dimensional video data. This makes it possible to generate a saliency map with high accuracy and to distribute a high-quality virtual video using the saliency map.

The information processing apparatus may further include a prediction unit that generates the field-of-view information in a future as predicted field-of-view information on the basis of the saliency map. In this case, the rendering unit may generate the two-dimensional video data on the basis of the predicted field-of-view information.

The field-of-view information may include at least one of a viewpoint position, a line-of-sight direction, a rotational angle of a line of sight, a head position of the user, or a rotational angle of a head of the user.

The field-of-view information may include the rotational angle of the head of the user. In this case, the prediction unit may predict a future rotational angle of the head of the user on the basis of the saliency map.

The two-dimensional video data may be configured by a plurality of frame images consecutive in time series. In this case, the rendering unit may generate a frame image on the basis of the predicted field-of-view information and may output the frame image as a predicted frame image.

The prediction unit may generate the predicted field-of-view information on the basis of history information of the field-of-view information and the saliency map.

The information processing apparatus may further include an acquisition unit that acquires the field-of-view information in real time. In this case, the prediction unit may generate the predicted field-of-view information on the basis of history information of the field-of-view information to a current time and the saliency map representing a saliency of the predicted frame image corresponding to the current time.

The prediction unit may generate, if the saliency map representing the saliency of the predicted frame image corresponding to the current time is not generated, the predicted field-of-view information on the basis of the history information of the field-of-view information to the current time.

The rendering unit may generate the parameter regarding the rendering processing on the basis of the three-dimensional space data and the field-of-view information.

The parameter regarding the rendering processing may include at least one of information of a distance to an object to be rendered or motion information of an object to be rendered.

The parameter regarding the rendering processing may include at least one of luminance information of an object to be rendered or color information of an object to be rendered.

The three-dimensional space data may include three-dimensional space description data that defines a configuration of a three-dimensional space, and three-dimensional object data that defines a three-dimensional object in the three-dimensional space. In this case, the generation unit may generate the saliency map on the basis of the parameter regarding the rendering processing and the three-dimensional space description data.

The three-dimensional space description data may include a degree of importance of an object to be rendered.

The generation unit may calculate a first coefficient on the basis of at least one of a determination result of whether or not the object is included in the field of view of the user, information of a distance to the object, or a determination result of whether or not the object has been previously included in the field of view of the user, and may generate the saliency map on the basis of a result of integrating the first coefficient to the degree of importance.

The generation unit may calculate a second coefficient on the basis of a situation in which occlusion occurs with respect to the object by another object, and may generate the saliency map on the basis of a result of integrating the second coefficient to the degree of importance.

A third coefficient may be calculated on the basis of a degree of preference of the user with respect to the object, and the saliency map may be generated on the basis of a result of integrating the third coefficient to the degree of importance.

The three-dimensional space description data may include identification information for identifying an object to be rendered. In this case, the information processing apparatus may further include a calculation unit that calculates a degree of preference of the user with respect to the object on the basis of the identification information. Further, the generation unit may generate the saliency map on the basis of the parameter regarding the rendering processing and the degree of preference of the user.

A data format of the three-dimensional space description data may be glTF (GL Transmission Format).

The three-dimensional space description data may include a degree of importance of an object to be rendered. In this case, the degree of importance may be stored in an extended region of a node corresponding to the object, or may be is stored in an extended region of a node added to store the degree of importance of the object in association with the object.

An information processing method according to an embodiment of the present technology is an information processing method executed by a computer system, and the information processing method includes: performing rendering processing on three-dimensional space data on the basis of field-of-view information regarding a field of view of a user, to generate two-dimensional video data corresponding to the field of view of the user; and generating a saliency map representing a saliency of the two-dimensional video data on the basis of a parameter regarding the rendering processing.

### BRIEF DESCRIPTION OF DRAWINGS

FIG. 1 is a schematic diagram showing a basic configuration example of a server-side rendering system.

FIG. 2 is a schematic diagram for describing an example of a virtual video that can be viewed by a user.

FIG. 3 is a schematic diagram for describing rendering processing.

FIG. 4 is a schematic diagram showing a configuration example of a server-side rendering system according to a first embodiment.

FIG. 5 is a schematic diagram for describing examples of rendering information.

FIG. 6 is a schematic diagram for describing other examples of the rendering information.

FIG. 7 is a flowchart showing an example of generation of a rendered video.

FIG. 8 is a diagram for describing the flowchart shown in FIG. 7 and schematically showing timings of acquisition and generation of each piece of information.

FIG. 9 is a schematic diagram showing an example of generation of a saliency map.

FIG. 10 is a schematic diagram showing an example of generation of a saliency map.

FIG. 11 is a schematic diagram showing a first example of information described in a scene description file, which is used as scene description information according to a second embodiment.

FIG. 12 is a flowchart showing an example of generation of a rendered video.

FIG. 13 is a schematic diagram showing an example of generation of a saliency map.

FIG. 14 is a schematic diagram showing a configuration example of a server-side rendering system according to a third embodiment.

FIG. 15 is a schematic diagram showing an example of information described in a scene description file, which is used as scene description information.

FIG. 16 is a flowchart showing an example of generation of a rendered video.

FIG. 17 is a schematic diagram showing an example of generation of a saliency map.

FIG. 18 is a block diagram showing a hardware configuration example of a computer (information processing apparatus) that can implement a server apparatus and a client apparatus.

FIG. 19 is a schematic diagram showing a second example of the information described in the scene description file in the second embodiment.

FIG. 20 is a schematic diagram showing a first example in which the degree of importance of each object is described when a glTF is used as the scene description information.

FIG. 21 is a schematic diagram showing a description example in the glTF when an extras field defined by the glTF is used as a method of giving the degree of importance to a node that refers to mesh.

FIG. 22 is a schematic diagram showing a description example in the glTF when an extensions region defined by the glTF is used as a method of giving the degree of importance to a node that refers to mesh.

FIG. 23 is a schematic diagram showing a second example in which the degree of importance of each object is described when a glTF is used as the scene description information.

FIG. 24 is a schematic diagram showing a description example in the glTF when a value of the degree of importance of each object is stored in an extensions region of an independent node.

FIG. 25 is a flowchart showing a processing procedure of another example in which a saliency map is generated from scene description information (degree of importance).

### MODE(S) FOR CARRYING OUT THE INVENTION

Hereinafter, embodiments according to the present technology will be described with reference to the drawings.

### [Server-Side Rendering System]

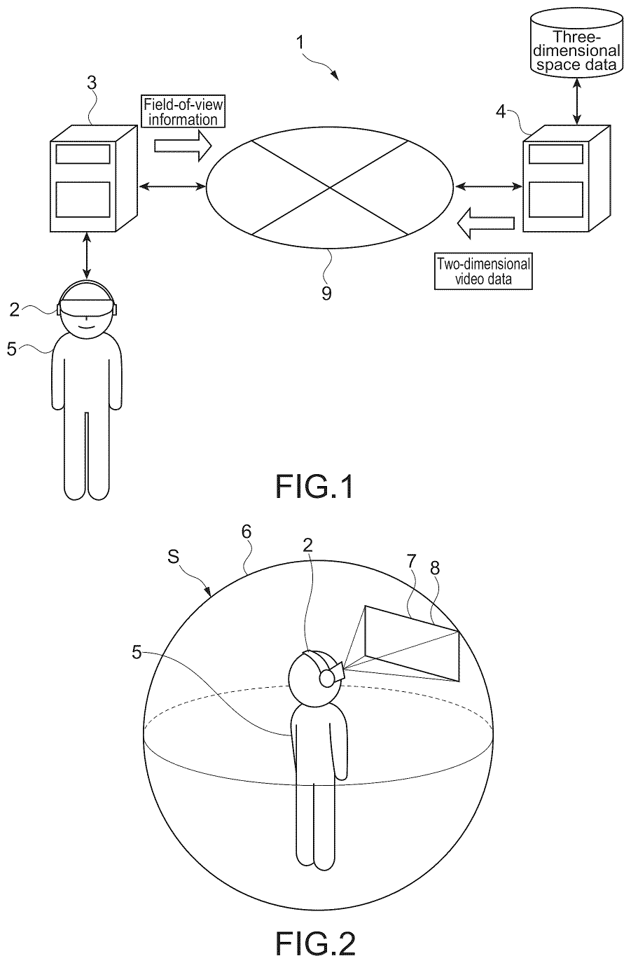

As one embodiment according to the present technology, a server-side rendering system is configured. First, a basic configuration example and a basic operation example of the server-side rendering system will be described with reference to FIGS. 1 to 3.

FIG. 1 is a schematic diagram showing the basic configuration example of the server-side rendering system.

FIG. 2 is a schematic diagram for describing an example of a virtual video that can be viewed by a user.

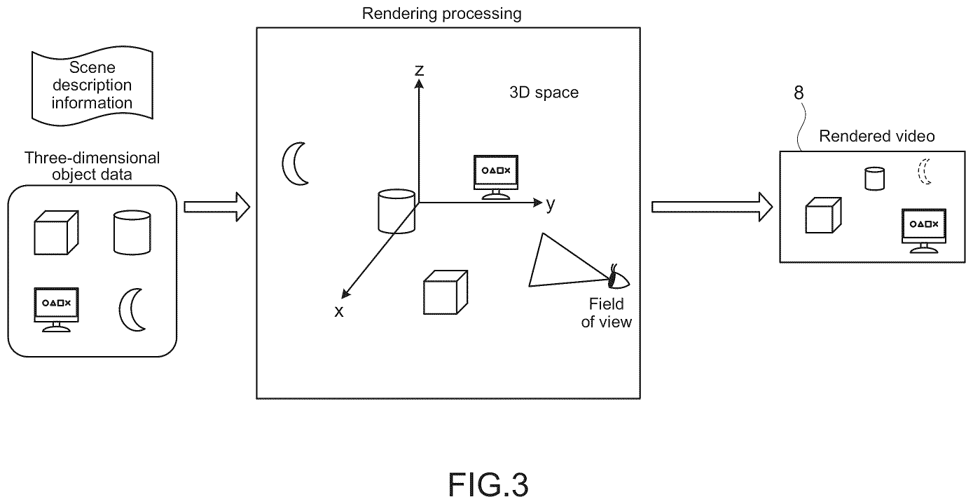

FIG. 3 is a schematic diagram for describing rendering processing.

Note that the server-side rendering system can also be referred to as a server-rendering-type media distribution system.

As shown in FIG. 1, a server-side rendering system 1 includes a head mounted display (HMD) 2, a client apparatus 3, and a server apparatus 4.

The HMD 2 is a device used for displaying a virtual video to a user 5. The HMD 2 is mounted on the head of the user 5 and used.

For example, if a VR video is distributed as a virtual video, an immersive HMD 2 configured to cover the field of view of the user 5 is used.

If an augmented reality (AR) video is distributed as a virtual video, AR glasses or the like are used as the HMD 2.

A device other than the HMD 2 may be used as a device for providing a virtual video to the user 5. For example, a virtual video may be displayed by a display provided to a television set, a smartphone, a tablet terminal, a personal computer (PC), or the like.

As shown in FIG. 2, in this embodiment, an omnidirectional video 6 is provided as a VR video to the user 5 wearing the immersive HMD 2. Further, the omnidirectional video 6 is provided as a 6 DoF video to the user 5.

The user 5 can view the video in a range of 360° around the entire circumference of the front and back, right and left, and up and down in a virtual space S formed of a three-dimensional space. For example, the user 5 freely moves a viewpoint position, a line-of-sight direction, and the like in the virtual space S, and freely changes the user's field of view (field-of-view range) 7. In response to the change of the field of view 7 of the user 5, a video 8 displayed to the user 5 is switched. The user 5 performs operations such as changing the direction of the face, tilting the face, and looking back, so that the user can view the surroundings in the virtual space S with the same feeling as in the real world.

As described above, in the server-side rendering system 1 according to this embodiment, it is possible to distribute a photorealistic free-viewpoint video, and it is possible to provide a viewing experience at a free viewpoint position.

As shown in FIG. 1, in this embodiment, field-of-view information is acquired by the HMD 2.

The field-of-view information is information regarding the field of view 7 of the user 5. Specifically, the field-of-view information includes any information capable of specifying the field of view 7 of the user 5 in the virtual space S.

Examples of the field-of-view information include a viewpoint position, a line-of-sight direction, and a rotational angle of the line of sight. Further, examples of the field-of-view information include a position of the head of the user 5 and a rotational angle of the head of the user 5.

The rotational angle of the line of sight can be defined by, for example, a rotational angle with an axis extending in the line-of-sight direction as a rotation axis. Further, the rotational angle of the head of the user 5 can be defined by a roll angle, a pitch angle, and a yaw angle in a case where three mutually orthogonal axes set with respect to the head are a roll axis, a pitch axis, and a yaw axis, respectively.

For example, an axis extending in the front direction of the face is defined as a roll axis. When the face of the user 5 is viewed from the front, an axis extending in the left-right direction is defined as a pitch axis, and an axis extending in the up-down direction is defined as a yaw axis. The roll angle, the pitch angle, and the yaw angle with respect to the roll axis, the pitch axis, and the yaw axis are calculated as the rotational angles of the head. Note that the direction of the roll axis can also be used as the line-of-sight direction.

In addition, any information capable of specifying the field of view of the user 5 may be used. As the field-of-view information, one piece of information exemplified above may be used, or a plurality of pieces of information exemplified above may be used in combination.

The method of acquiring the field-of-view information is not limited. For example, the field-of-view information can be acquired on the basis of a detection result (sensing result) by a sensor device (including camera) provided to the HMD 2.

For example, the HMD 2 is provided with a camera or ranging sensor having a detection range corresponding to the surroundings of the user 5, an inward-facing camera that can capture images of the left and right eyes of the user 5, and the like. Further, the HMD 2 is also provided with an inertial measurement unit (IMU) sensor or a GPS.

For example, position information of the HMD 2 acquired by the GPS can be used as a viewpoint position of the user 5 or a position of the head of the user 5. As a matter of course, positions of the left and right eyes of the user 5, or the like may be calculated in more detail.

Further, it is also possible to detect a line-of-sight direction from the captured images of the left and right eyes of the user 5.

Further, it is also possible to detect a rotational angle of the line of sight or a rotational angle of the head of the user 5 from a detection result of the IMU.

Further, self-position estimation of the user 5 (HMD 2) may be performed on the basis of a detection result by the sensor device provided to the HMD 2. For example, position information of the HMD 2, posture information such as a direction in which the HMD 2 faces, or the like can be calculated by the self-position estimation. The field-of-view information can be acquired from the position information and the posture information.

The algorithm for estimating the self-position of the HMD 2 is not limited, and any algorithm such as simultaneous localization and mapping (SLAM) may be used.

Further, head tracking for detecting the movement of the head of the user 5 or eye tracking for detecting the movements of the left and right lines of sight of the user 5 may be executed.

In addition, any device or any algorithm may be used to acquire the field-of-view information. For example, in a case where a smartphone or the like is used as a device for displaying a virtual video to the user 5, the face (head) or the like of the user 5 may be imaged, and the field-of-view information may be acquired on the basis of the captured image.

Alternatively, a device including a camera, an IMU, or the like may be mounted on the head or around the eyes of the user 5.

Any machine-learning algorithm using, for example, a deep neural network (DNN) may be used to generate the field-of-view information. For example, use of artificial intelligence (AI) or the like that performs deep learning (deep machine learning) makes it possible to improve a generation accuracy of the field-of-view information.

Note that the machine-learning algorithm may be applied to any processing in the present disclosure.

The HMD 2 and the client apparatus 3 are communicably connected to each other. A communication form for communicably connecting both devices to each other is not limited, and any communication technology may be used. For example, wireless network communication such as Wi-Fi or near field communication such as Bluetooth (registered trademark) can be used.

The HMD 2 transmits the field-of-view information to the client apparatus 3.

Note that the HMD 2 and the client apparatus 3 may be integrally provided. In other words, the function of the client apparatus 3 may be implemented in the HMD 2.

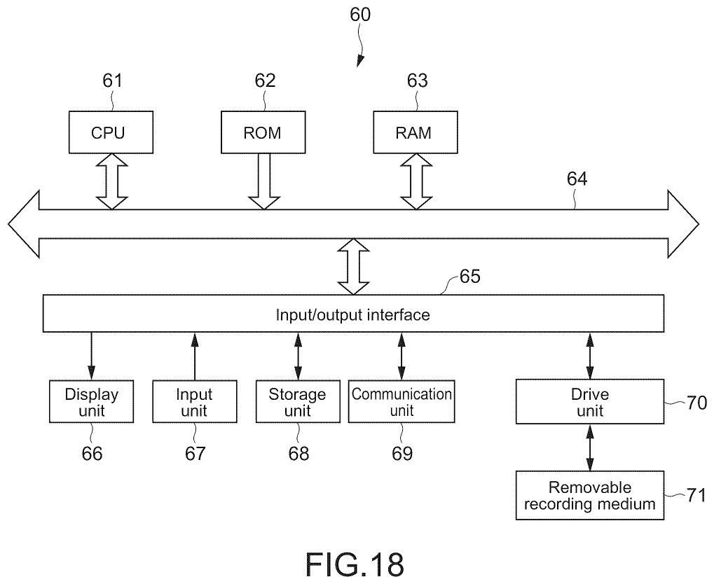

The client apparatus 3 and the server apparatus 4 each have hardware necessary for the configuration of a computer, such as a CPU, a ROM, a RAM, and an HDD (see FIG. 18). The CPU loads a program according to the present technology, which is recorded in advance in the ROM or the like, into the RAM and executes the program, thus executing an information processing method according to the present technology.

For example, the client apparatus 3 and the server apparatus 4 can be provided using any computer such as a personal computer (PC). As a matter of course, hardware such as an FPGA or ASIC may be used.

Of course, the present technology is not limited to a case where the client apparatus 3 and the server apparatus 4 have the same configuration.

The client apparatus 3 and the server apparatus 4 are communicably connected to each other via a network 9.

The network 9 is established by, for example, the Internet or a wide area communication network. In addition, any wide area network (WAN), any local area network (LAN), or the like may be used, and a protocol for establishing the network 9 is not limited.

The client apparatus 3 receives the field-of-view information transmitted from the HMD 2. Further, the client apparatus 3 transmits the field-of-view information to the server apparatus 4 via the network 9.

The server apparatus 4 receives the field-of-view information transmitted from the client apparatus 3. Further, the server apparatus 4 performs rendering processing on three-dimensional space data on the basis of the field-of-view information, to generate two-dimensional video data (rendered video) corresponding to the field of view 7 of the user 5.

The server apparatus 4 corresponds to an embodiment of an information processing apparatus according to the present technology. The server apparatus 4 executes an embodiment of an information processing method according to the present technology.

As shown in FIG. 3, the three-dimensional space data includes scene description information and three-dimensional object data.

The scene description information corresponds to three-dimensional space description data that defines a configuration of a three-dimensional space (virtual space S). The scene description information includes various pieces of meta data for reproducing the scenes of 6 DoF content.

The three-dimensional object data is data that defines a three-dimensional object in the three-dimensional space. In other words, the three-dimensional object data is data of each object constituting each scene of the 6 DoF content.

For example, data of a three-dimensional object such as a person or an animal, and data of a three-dimensional object such as a building or a tree are stored. Alternatively, data of a three-dimensional object such as sky or sea constituting a background or the like is stored. A plurality of types of objects may be collectively configured as one three-dimensional object, and the data thereof may be stored.

The three-dimensional object data includes, for example, mesh data that can be represented as shape data of a polyhedron, and texture data that is data attached to the surface of the mesh data. Alternatively, the three-dimensional object data includes a set of a plurality of points (point group) (Point Cloud).

As shown in FIG. 3, the server apparatus 4 reproduces the three-dimensional space by arranging the three-dimensional objects in the three-dimensional space on the basis of the scene description information. The server apparatus 4 then cuts out a video viewed from the user 5 (rendering processing) with the reproduced three-dimensional space as a reference, thus generating a rendered video that is a two-dimensional video to be viewed by the user 5.

The server apparatus 4 encodes the generated rendered video and transmits the encoded video to the client apparatus 3 via the network 9.

Note that the rendered video corresponding to the field of view 7 of the user can also be referred to as a video of a viewport (display region) corresponding to the field of view 7 of the user.

The client apparatus 3 decodes the encoded rendered video transmitted from the server apparatus 4. Further, the client apparatus 3 transmits the decoded rendered video to the HMD 2.

As shown in FIG. 2, the rendered video is reproduced by the HMD 2 and displayed to the user 5. Hereinafter, the video 8 displayed to the user 5 by the HMD 2 may be referred to as a rendered video 8.

### [Advantages of Server-Side Rendering System]

Other distribution systems for the omnidirectional video 6 (6 DoF video) as shown in FIG. 2 include a client-side rendering system.

In the client-side rendering system, the client apparatus 3 performs rendering processing on three-dimensional space data on the basis of the field-of-view information, and generates two-dimensional video data (rendered video 8). The client-side rendering system can also be referred to as a client-rendering-type media distribution system.

In the client-side rendering system, it is necessary to distribute three-dimensional space data (three-dimensional space description data and three-dimensional object data) from the server apparatus 4 to the client apparatus 3.

The three-dimensional object data includes mesh data or includes point cloud data (Point Cloud). Therefore, the amount of distribution data from the server apparatus 4 to the client apparatus 3 becomes enormous. Further, in order to execute the rendering processing, the client apparatus 3 is required to have a considerably high processing capability.

In contrast to this, in the server-side rendering system 1 according to this embodiment, the rendered video 8 after subjected to rendering is distributed to the client apparatus 3. This makes it possible to sufficiently suppress the amount of distribution data. In other words, this makes it possible for the user 5 to experience a large-space 6 DoF video including a huge amount of three-dimensional object data, with a small amount of distribution data.

Further, a processing load on the client apparatus 3 side can be offloaded to the server apparatus 4 side. Even if the client apparatus 3 having a lower processing capability is used, the user 5 can experience a 6 DoF video.

### [Problem of Response Delay]

In the server-side rendering system 1, the field-of-view information of the user 5 or the rendered video 8 after subjected to rendering is transmitted and received via the network 9. Therefore, there is a possibility that a response delay occurs in displaying the rendered video 8 according to the movement of the viewpoint or the like.

For example, the user 5 changes the field of view 7 by an action such as moving the head. The field-of-view information is acquired by the HMD 2 and transmitted to the client apparatus 3. The client apparatus 3 transmits the received field-of-view information to the server apparatus 4 via the network 9.

The server apparatus 4 performs rendering processing on three-dimensional space data on the basis of the received field-of-view information of the user 5, and generates a rendered video 8. The generated rendered video 8 is encoded and transmitted to the client apparatus 3 via the network 9.

The client apparatus 3 decodes the received rendered video 8 and transmits the decoded rendered video 8 to the HMD 2. The HMD 2 displays the received rendered video 8 to the user 5.

The server-side rendering system 1 is established to execute such a processing flow in real time in response to a change in the field of view of the user 5. In this case, a delay caused from a change in field of view of the user 5 to reflection of the change in a video for the HMD 2 may occur as a response delay.

Note that such a response delay can also be represented as (Motion-to-Photon Latency: T_m2p). It is considered desirable that a delay time of such a response delay is equal to or less than 20 msec, which is considered to be a human perception threshold.

The present technology is a very effective technology for solving the above-mentioned problem of the response delay. Hereinafter, embodiments of the server-side rendering system 1 to which the present technology is applied will be described in detail.

In the following embodiments, a case where Head Motion information is used as the field-of-view information of the user 5 will be described as an example.

The Head Motion information includes Position information (X, Y, Z) representing a position movement of the head of the user 5 and Orientation information (yaw, pitch, roll) representing a motion of a rotational movement of the head of the user 5.

The Position information (X, Y, Z) corresponds to the position information in the virtual space S, and is defined by coordinate values of an XYZ coordinate system that is set in the virtual space S. The method of setting the XYZ coordinate system is not limited.

The Orientation information (yaw, pitch, roll) is defined by a roll angle, a pitch angle, and a yaw angle regarding the mutually orthogonal roll axis, pitch axis, and yaw axis that are set for the head of the user 5.

As a matter of course, the application of the present technology is not limited to a case where the Head Motion information (X, Y, Z, yaw, pitch, roll) is used as the field-of-view information of the user 5. The present technology is applicable even if other information is used as the field-of-view information.

Further, in the following embodiments, the server-side rendering system 1 acquires the field-of-view information of the user 5 in real time, and displays a rendered video to the user 5.

Description will be given assuming that the time, at which the field-of-view information of the user 5 is acquired by the server-side rendering system 1, is a “current time”. In other words, the time at which the field-of-view information of the user 5 is acquired by the HMD 2 is referred to as a “current time”.

As described above, a response delay (time corresponding to T_m2pa) may occur when the field-of-view information acquired at the “current time” is transmitted to the server apparatus 4 and the rendered video 8 is then generated and displayed by the HMD 2.

Applying the present technology makes it possible to sufficiently suppress the problem of the response delay from the “current time”, which achieves distribution of a high-quality virtual video.

### First Embodiment

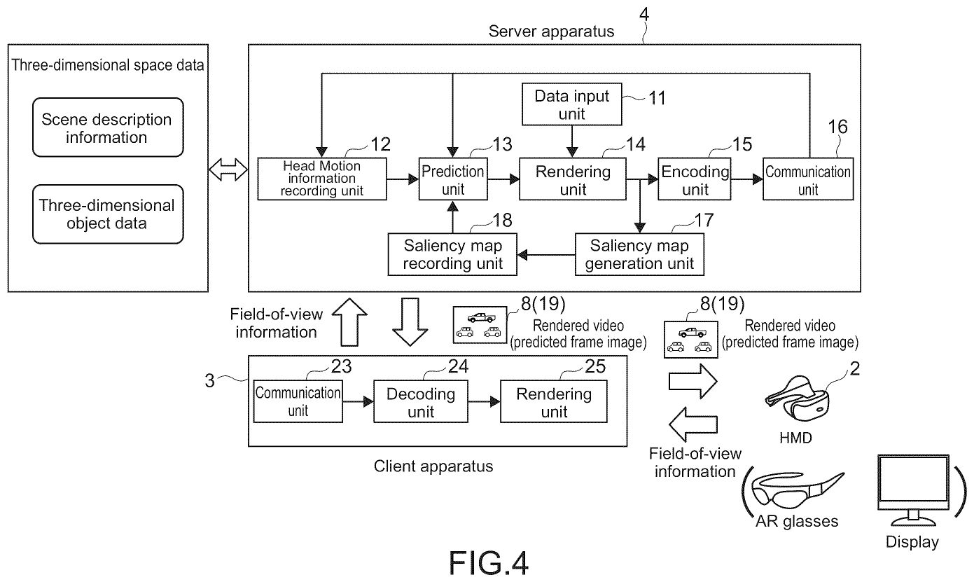

FIG. 4 is a schematic diagram showing a configuration example of a server-side rendering system 1 according to a first embodiment.

The server-side rendering system 1 shown in FIG. 4 includes an HMD 2, a client apparatus 3, and a server apparatus 4.

The HMD 2 is capable of acquiring field-of-view information (Head Motion information) of a user 5 in real time. As described above, the time at which the Head Motion information is acquired by the HMD 2 is a current time.

The HMD 2 acquires Head Motion information at a predetermined frame rate and transmits the Head Motion information to the client apparatus 3. Therefore, “Head Motion information of a current time” is repeatedly transmitted to the client apparatus 3 at a predetermined frame rate.

Similarly, the “Head Motion information of a current time” is repeatedly transmitted from the client apparatus 3 to the server apparatus 4 as well at a predetermined frame rate.

The frame rate for acquiring the Head Motion information (number of times of acquiring Head Motion information/second) is set so as to be synchronized with the frame rate of the rendered video 8, for example.

For example, the rendered video 8 includes a plurality of frame images consecutive in time series. Each frame image is generated at a predetermined frame rate. The frame rate for acquiring the Head Motion information is set so as to be synchronized with the frame rate of the rendered video 8. As a matter of course, the present technology is not limited to the above.

Further, as described above, AR glasses or a display may be used as a device for displaying a virtual video to the user 5.

The server apparatus 4 includes a data input unit 11, a Head Motion information recording unit 12, a prediction unit 13, a rendering unit 14, an encoding unit 15, and a communication unit 16. The server apparatus 4 also includes a saliency map generation unit 17 and a saliency map recording unit 18.

Those functional blocks are implemented by, for example, a CPU executing a program according to the present technology, and an information processing method according to this embodiment is executed. Note that, in order to implement each functional block, dedicated hardware such as an integrated circuit (IC) may be appropriately used.

The data input unit 11 reads three-dimensional space data (scene description information and three-dimensional object data) and outputs the three-dimensional space data to the rendering unit 14.

Note that the three-dimensional space data is stored in, for example, a storage unit 68 of the server apparatus 4 (see FIG. 18). Alternatively, the three-dimensional space data may be managed by a content server or the like communicably connected to the server apparatus 4. In this case, the data input unit 11 acquires the three-dimensional space data by accessing the content server.

The communication unit 16 is a module for executing network communication, near field communication, and the like with other devices. For example, a wireless LAN module for Wi-Fi or the like, and a communication module for Bluetooth (registered trademark) or the like are provided.

In this embodiment, the communication unit 16 provides communication with the client apparatus 3 via the network 9.

The Head Motion information recording unit 12 records the field-of-view information (Head Motion information), which is received from the client apparatus 3 via the communication unit 16, in the storage unit 68 (see FIG. 18). For example, a buffer or the like for recording the field-of-view information (Head Motion information) may also be configured.

The “Head Motion information of a current time” transmitted at a predetermined frame rate is stored and held in the storage unit 68.

The prediction unit 13 generates future field-of-view information as predicted field-of-view information on the basis of a saliency map. In this embodiment, future Head Motion information of the user 5 is predicted and generated as predicted Head Motion information.

The predicted Head Motion information includes future Position information (X, Y, Z) and future Orientation information (yaw, pitch, roll). In other words, in this embodiment, the position of the head and the rotational angle of the head are predicted on the basis of the saliency map.

The saliency map is information representing the saliency of the rendered video (two-dimensional video data) 8, and is information obtained by estimating, from the mechanism of human visual attention, how easily each pixel of the rendered video 8 attracts attention, and quantitatively representing it. The saliency map will also be referred to as a saliency map.

The rendering unit 14 performs the rendering processing shown in FIG. 3. In other words, the rendering unit 14 performs the rendering processing on the three-dimensional space data on the basis of the field-of-view information regarding the field of view of the user 5, to generate the rendered video 8 corresponding to the field of view 7 of the user 5.

In this embodiment, the rendering unit 14 generates frame images constituting the rendered video 8 on the basis of the predicted field-of-view information (predicted Head Motion information) generated by the prediction unit 13. Hereinafter, the frame image generated on the basis of the predicted Head Motion information will be referred to as a predicted frame image 19.

The rendering unit 14 includes, for example, a reproduction section that reproduces a three-dimensional space, a renderer, a parameter setting section that sets rendering parameters, and the like. Examples of the rendering parameters include a resolution map indicating the resolution of each region.

In addition, any configuration may be employed as the rendering unit 14.

The encoding unit 15 performs encoding processing (compression coding) on the rendered video 8 (predicted frame image 19) to generate distribution data. The distribution data is transmitted to the client apparatus 3 via the communication unit 16.

For example, the encoding processing is performed in real time on each region of the rendered video 8 (predicted frame image 19) on the basis of a QP map (quantization parameters).

More specifically, in this embodiment, the encoding unit 15 switches a quantization accuracy (QP: quantization parameters) for each region in the predicted frame image 19, so that it is possible to suppress image quality degradation due to the compression in a point of interest or a critical region in the predicted frame image 19.

In such a manner, it is possible to suppress an increase in the load of distribution data and processing while maintaining sufficient video quality for a region important to the user 5. Note that here, the QP value is a value indicating the scale of quantization in lossless compression efficiency. As the QP value becomes higher, the coding amount becomes smaller, the compression efficiency becomes higher, and the image quality deterioration due to compression proceeds, whereas as the QP value become lower, the coding amount becomes larger, the compression efficiency becomes lower, and the image quality deterioration due to compression can be suppressed.

In addition, any compression coding technology may be used.

The encoding unit 15 includes, for example, an encoder, a parameter setting section that sets encoding parameters, and the like. Examples of the encoding parameters include the QP map described above.

For example, the QP map is generated on the basis of a resolution map, which is set by the parameter setting section of the rendering unit 14. In addition, any configuration may be employed as the encoding unit 15.

The saliency map generation unit 17 generates a saliency map representing the saliency of the two-dimensional video data (predicted frame image 19) on the basis of the parameters regarding the rendering processing.

The parameters regarding the rendering processing include any information used to generate the rendered video 8. Further, the parameters regarding the rendering processing also include any information that can be generated using the information used to generate the rendered video 8.

For example, the rendering unit 14 generates the parameters regarding the rendering processing on the basis of the three-dimensional space data and the field-of-view information (predicted field-of-view information). As a matter of course, the present technology is not limited to such a generation method.

Hereinafter, the parameters regarding the rendering processing may be referred to as rendering information.

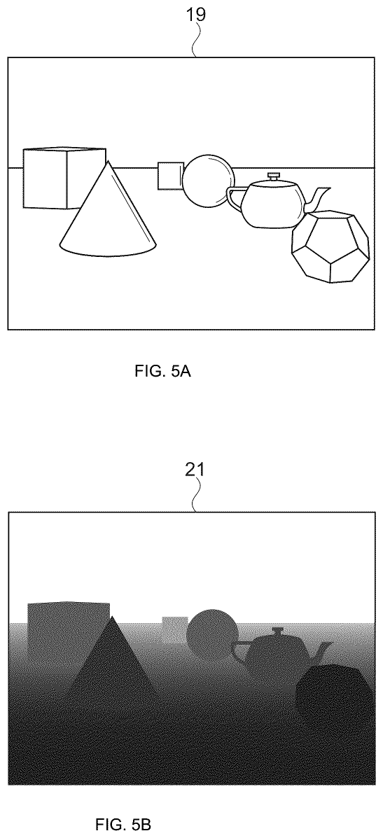

FIG. 5 is a schematic diagram for describing examples of the rendering information.

A of FIG. 5 is a schematic diagram showing the predicted frame image 19 generated by the rendering processing. B of FIG. 5 is a schematic diagram showing a depth map (depth map image) 21 corresponding to the predicted frame image 19.

The depth map 21 can be used as the rendering information. The depth map 21 is data including information of a distance to an object to be rendered (depth information). The depth map 21 can also be referred to as a depth information map or a distance information map.

For example, image data, in which the distance is converted into luminance, can also be used as the depth map 21. As a matter of course, the present technology is not limited to such a form.

The depth map 21 can be generated, for example, on the basis of the three-dimensional space data and the field-of-view information (predicted field-of-view information).

For example, in 3D rendering, when a certain object is to be rendered, it is necessary to check an anteroposterior relationship with the objects that have already been rendered. In this case, a Z buffer is used.

The Z buffer is a buffer that temporarily stores depth information (having the same resolution as that of rendered image) of a current rendered image.

In rendering of an object, if there is another object that has already been rendered in that pixel, the renderer checks the anteroposterior relationship with that object. The following determination is then made on a pixel-by-pixel basis: if the current object is located forward, rendering is performed; otherwise, rendering is not performed.

The Z buffer is used for the check at that time. A depth value of an object rendered so far is written in a corresponding pixel, and the check is performed by referring to the depth value. The depth value is set for the pixel that has been checked and newly rendered, and the pixel is updated.

In other words, the renderer also holds depth map image data of a corresponding frame therein at the timing at which the rendering of the predicted frame image 19 is completed.

Note that the method of acquiring the depth map 21 as the rendering information is not limited, and any method can be employed.

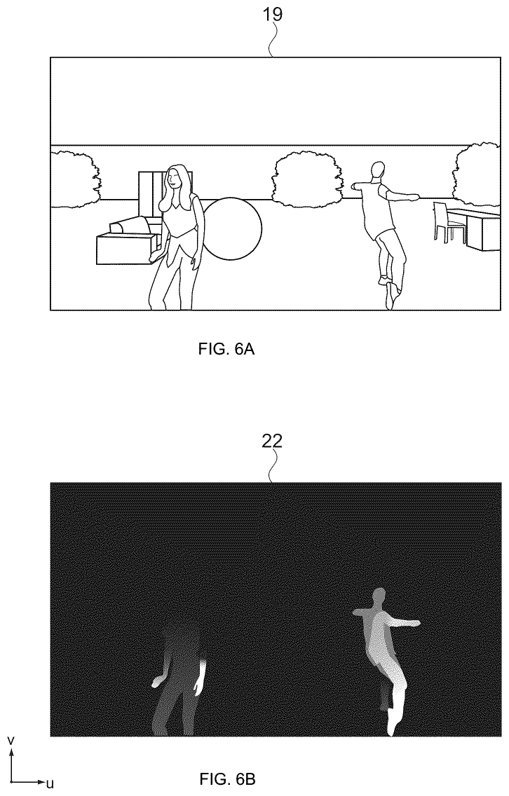

FIG. 6 is a schematic diagram for describing other examples of the rendering information.

A of FIG. 6 is a schematic diagram showing a predicted frame image 19 generated by the rendering processing. B of FIG. 6 is a schematic diagram showing a motion vector map (motion vector map image) 22 corresponding to the predicted frame image 19.

The motion vector map 22 can be used as the rendering information. The motion vector map is data including motion information of an object to be rendered.

In the examples shown in FIG. 6, a person with long hair on the left side is dancing while lightly moving both arms. A person with short hair on the right side is dancing while largely moving the whole body.

For example, a component (movement amount) in the horizontal direction (U direction) of the motion vector is represented by red (R), and a component (movement amount) in the vertical direction (V direction) of the motion vector is represented by green (G). This makes it possible to use image data, in which the motion vector is visualized, as the motion vector map 22. As a matter of course, the present technology is not limited such a form.

The motion vector map 22 can be generated, for example, on the basis of the three-dimensional space data and the field-of-view information (predicted field-of-view information).

Position information of a vertex that is held by 3D object data is a value in model coordinates centered on the origin at modelling.

In 3D rendering, position information of each object and each point is converted from model coordinates into viewport coordinates (normalized screen coordinates) by using an MVP matrix obtained by multiplying: a model matrix (4×4 matrices constituted by information such as Position, Rotation, and Scale for conversion from model space to world space); a view matrix (4×4 matrices constituted by position and direction information of camera (viewpoint) for conversion from world space to view space); and a projection matrix (4×4 matrices constituted by information such as angle of view of camera and Near and Far of Clipping plane for conversion from view space to projection space).

This MVP matrix is determined by the position/direction information of the object at the time of rendering and information such as the position/direction/angle of view of the camera, and coordinate conversion is performed using this matrix to determine at which position of a 2D image each point data of the object is rendered.

Therefore, the MVP matrix of one frame before is held to calculate a difference from the coordinate conversion value of the current matrix at the time of rendering, so that it is possible to accurately acquire motion vector information indicating how much each point has moved from the previous frame.

Performing this operation on all points to be rendered makes it possible to calculate the motion vector map 22 with the same resolution as that of the rendered image.

Note that the method of acquiring the motion vector map 22 as the rendering information is not limited, and any method may be employed. Further, information different from the motion vector map 22 may be acquired as the motion information.

The saliency map recording unit 18 records the saliency map generated by the saliency map generation unit 17 in the storage unit 68 (see FIG. 18). For example, a buffer or the like for recording the saliency map may be configured.

In this embodiment, the rendering unit 14 functions as an embodiment of a rendering unit according to the present technology.

The encoding unit 15 functions as an embodiment of an encoding unit according to the present technology.

The saliency map generation unit 17 functions as an embodiment of a generation unit according to the present technology.

The prediction unit 13 functions as an embodiment of a prediction unit according to the present technology.

The communication unit 16 functions as an embodiment of an acquisition unit that acquires the field-of-view information in real time.

The client apparatus 3 includes a communication unit 23, a decoding unit 24, and a rendering unit 25.

Those functional blocks are implemented by, for example, a CPU executing a program according to the present technology, and an information processing method according to this embodiment is executed. Note that, in order to implement each functional block, dedicated hardware such as an integrated circuit (IC) may be appropriately used.

The communication unit 23 is a module for executing network communication, near field communication, and the like with other devices. For example, a wireless LAN module for Wi-Fi or the like, and a communication module for Bluetooth (registered trademark) or the like are provided.

The decoding unit 24 performs decoding processing on the distribution data. Thus, the encoded rendered video 8 (predicted frame image 19) is decoded.

The rendering unit 25 executes rendering processing such that the decoded rendered video 8 (predicted frame image 19) can be displayed by the HMD 2.

### [Prediction Accuracy of Head Motion Information]

For example, the server apparatus 4 that has received the “Head Motion information of a current time” generates predicted Head Motion information in a future corresponding to a response delay (T_m2pa time). The predicted frame image 19 is then generated on the basis of the predicted Head Motion information and displayed to the user 5 by the HMD 2.

If the predicted Head Motion information can be generated with very high accuracy, it is possible to display the rendered video 8, corresponding to the field of view 7 of the user 5, in a future corresponding to a response delay (T_m2pa time) from the “current time”, and to sufficiently suppress the problem of the response delay.

The inventors of the present invention have had many discussions on the Head Motion prediction in order to improve the accuracy of the predicted Head Motion information.

First, it can be seen that a prediction error of the Head Motion prediction tends to increase as the frequency of a head motion signal (sensoring result) increases.

In the characteristics of a human body, motion in the rotation direction provides motion having a sudden change (motion that results in high frequency). However, position movement such as front and rear, up and down, and left and right is less likely to provide high-frequency motion having a sudden change.

Therefore, among those two types of motion, a prediction error for the motion (X, Y, Z) in the position movement is low, and an effect on viewing is very small. On the other hand, a prediction error for the motion (yaw, pitch, roll) in the rotation direction tends to be large, which easily affects viewing. In other words, it is of great importance to improve the prediction accuracy for the motion (yaw, pitch, roll) in the rotation direction.

The inventors of the present invention have focused on a saliency map representing the saliency of a two-dimensional rendered video (two-dimensional frame image) to be viewed by the user 5, in order to improve the Head Motion prediction, particularly, the prediction accuracy for the motion (yaw, pitch, roll) in the rotation direction.

Generating a saliency map with high accuracy and using the saliency map for the Head Motion prediction makes it possible to perform the prediction accuracy for the motion (yaw, pitch, roll) in the rotation direction with very high accuracy.

Examples of the generation model of a saliency map include a generation model of a saliency map based on bottom-up attention.

In other words, feature amounts, such as luminance, color, direction, motion direction, and depth, that attract exogenous attention (bottom-up attention) due to visual stimuli before a human recognizes an object are extracted from a 2D video. Each feature map is calculated so as to assign a high degree of saliency to a region in which a value indicating each feature amount is largely different from the surrounding region, and the feature maps are integrated, so that a final saliency map is generated.

With regard to such saliency map generation, it is assumed that only a 2D video is input. In this case, among the visual features used for generating the saliency map, features such as color and luminance can be acquired directly from each pixel value of the 2D video. On the other hand, features such as depth and motion cannot be obtained directly.

In this regard, those features are estimated from an analysis of a 2D video. Therefore, there is no certainty in a saliency map generated on the basis of estimated values. In a case of real-time generation, an estimation time is limited, and thus an estimation accuracy is also lowered.

Further, the human visual attention includes exogenous attention (bottom-up attention) due to visual stimuli before an object is recognized, and intrinsic attention (top-down attention) due to interest in or attention to an object after the object is recognized.

Although the keyword “saliency” is used for both the bottom-up attention and the top-down attention, the generation model of the saliency map described above is for detecting a saliency based on the bottom-up attention.

On the other hand, since the top-down attention is directed as attention based on its meaning after an object is recognized, the saliency is given to the object.

For example, in a scene in which a user shows interest in a specific person among a plurality of persons, or a scene in which a user shows interest in an object other than a human, viewing situations (scenes) and interests of users are diverse. It is very difficult to accurately detect a saliency based on top-down attention of a user from only a 2D video in accordance with the situations and the users.

As described above, in a generation model in which only a generated 2D video is analyzed, and a saliency map is generated from the data thus obtained, there are problems that the reliability of saliency detection is insufficient in the following two points.
(1) Since visual features that attract bottom-up attention are extracted by estimation based on a two-dimensional image analysis, there is no certainty in accuracy. When real-time generation is performed, an estimation time is limited, and thus an estimation accuracy is lowered.
(2) It is difficult to perform accurate detection of top-down attention and reflection on a saliency map.

If a saliency map having a low reliability is used, it may adversely affect the Head Motion prediction, which makes it very difficult to apply to improving the prediction accuracy.

The present technology has been newly devised as an effective technology for the problem points (1) and (2) described above. In this embodiment (first embodiment), particularly, a solution of the problem point (1) can be achieved.

### [Operation of Generating Two-Dimensional Video Data (Rendered Video)]

An operation example of generating a rendered video by the server apparatus 4 will be described.

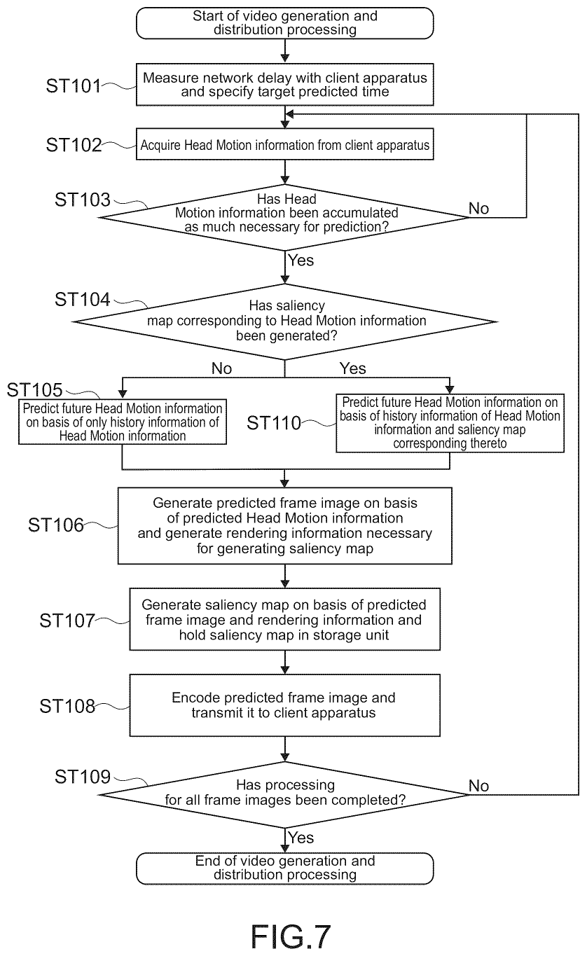

FIG. 7 is a flowchart showing an example of generation of a rendered video.

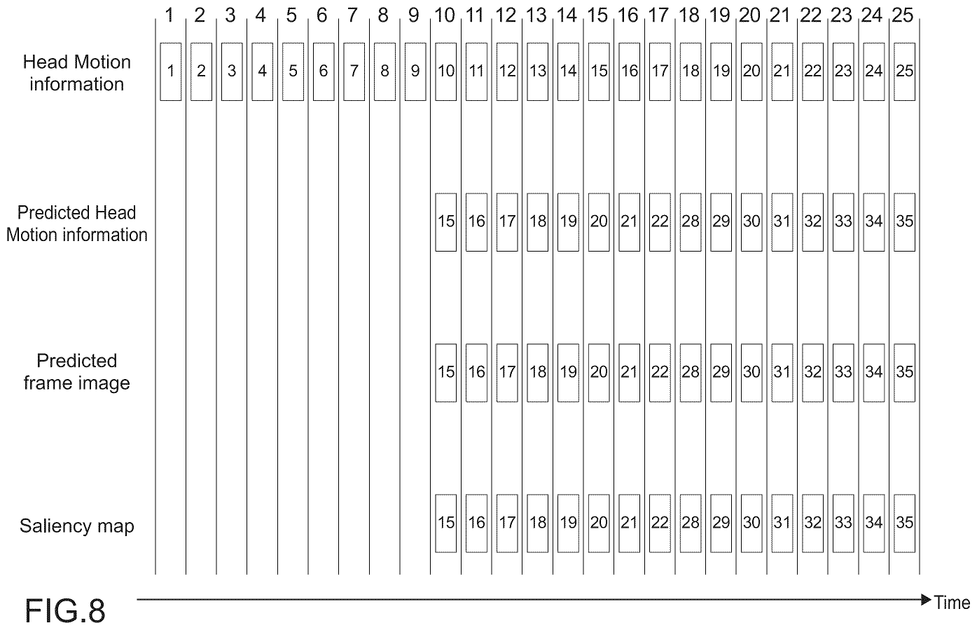

FIG. 8 is a diagram for describing the flowchart shown in FIG. 7 and schematically showing timings of acquisition of the Head Motion information, generation of the predicted Head Motion information, generation of the predicted frame image 19, and generation of the saliency map.

In this embodiment, to easily understand the description, it is assumed that the field-of-view information is acquired from the client apparatus 3 at a predetermined frame rate, and each of the predicted Head Motion information, the predicted frame image 19, and the saliency map is generated at the same frame rate. As a matter of course, the present technology is not limited to such processing.

A frame marked with a number shown in FIG. 8 represents a frame of each processing. FIG. 8 schematically shows the first frame, from which the processing is started, to the 25th frame.

Further, in each frame, a frame with a square figure represents that the data described on the left side has been acquired/generated. Further, the number in the square figure is a number indicating to which frame the data corresponds.

First, how far ahead of the “current time” is set to generate future predicted Head Motion information.

In this embodiment, the communication unit 16 measures a network delay with the client apparatus 3 and specifies a target predicted time (Step 101). In other words, a response delay (T_m2pa time) is measured, and time corresponding to T_m2pa is specified as a predicted time.

In this embodiment, Head Motion information in a future frame, which is a predetermined number of frames ahead of the frame corresponding to the “current time”, is predicted and generated as the predicted Head Motion information.

For the predetermined number of frames, the number of frames corresponding to the time corresponding to T_m2pa as a predicted time is set.

For example, in this embodiment, it is assumed that Head Motion information of five frames ahead is predicted. For example, when the “Head Motion information of a current time” is acquired in the 10th frame, the Head Motion information of the 15th frame, which is 5 frames ahead, is predicted and generated as the predicted Head Motion information. As a matter of course, the number of frames is not limited to a specific number and may be discretionally set.

The communication unit 16 acquires the Head Motion information from the client apparatus 3 (Step 102). As shown in FIG. 8, the Head Motion information is acquired at a predetermined frame rate from the first frame. The Head Motion information acquired in each frame is used without change as data corresponding to that frame.

The prediction unit 13 determines whether or not the Head Motion information has been accumulated as much necessary for the prediction of Head Motion information (Step 103).

In this embodiment, it is assumed that the Head Motion information corresponding to 10 frames are necessary to predict Head Motion information. As a matter of course, the number of frames is not limited to a specific number and may be discretionally set.

For example, since the amount of Head Motion information necessary for predicting Head Motion information is not accumulated from the first frame to the ninth frame, the processing proceeds to No of Step 103 and returns to Step 102. Therefore, the generation of the rendered video 8 (predicted frame image 19) is not executed to the 10th frame.

When the Head Motion information of the 10th frame is acquired, it is determined that the amount of Head Motion information necessary for predicting Head Motion information is accumulated, and the processing proceeds to Yes of Step 103 and proceeds to Step 104.

In Step 104, the prediction unit 13 determines whether or not the saliency map corresponding to the “Head Motion information of a current time” acquired in Step 102 has been generated.

In this embodiment, predicted field-of-view information (predicted Head Motion information) is generated by inputting history information of the field-of-view information (Head Motion information) to the current time and the saliency map corresponding to the current time. The saliency map corresponding to the current time is map data that represents the saliency of the predicted frame image 19 previously generated, as the predicted frame image 19 corresponding to the current time.

The saliency map corresponding to the “Head Motion information of a current time” means, in the example shown in FIG. 8, a saliency map corresponding to a frame in which the “Head Motion information of a current time” is acquired.

In other words, the frames having the same number in the square figure indicating the Head Motion information and in the square figure indicating the saliency map become a pair of the “Head Motion information of a current time” and the saliency map corresponding to each other.

For example, when the Head Motion information of the 10th frame is acquired, the frame corresponding to the current time is the 10th frame. In Step 104, it is determined whether or not a saliency map corresponding to the frame 10 (saliency map represented by a square figure in which the number 10 is described) has been generated.

As shown in FIG. 8, the predicted Head Motion information has not yet been generated up to the 10th frame, and the predicted frame image 19 has also not yet been generated. Therefore, since no saliency map has been generated, the processing proceeds to No of Step 104 and proceeds to Step 105.

In Step 105, the prediction unit 13 generates predicted field-of-view information (predicted Head Motion information) on the basis of the history information of the field-of-view information (Head Motion information) up to the current time.

As described above, if the saliency map of the frame corresponding to the current time is not generated, predicted Head Motion information may be generated on the basis of only the history information of the Head Motion information up to the current time.

In this embodiment, in the frame 10, future predicted Head Motion information of a frame, which is five frames ahead thereof, is generated on the basis of the history information of the Head Motion information from the frame 1 to the frame 10. Therefore, as shown in FIG. 8, in the 10th frame, future predicted Head Motion information corresponding to the frame 15, which is five frames ahead thereof, is generated (predicted Head Motion information represented by a square figure in which the number 15 is described).

A specific algorithm for generating the predicted Head Motion information on the basis of the history information of the Head Motion information up to the current time is not limited, and any algorithm may be used. For example, any machine-learning algorithm may also be used.

The rendering unit 14 executes the rendering processing shown in FIG. 3 on the basis of the predicted Head Motion information, and generates a rendered video 8 (predicted frame image 19) (Step 106). In this embodiment, a predicted frame image 19 corresponding to the frame 15 is generated on the basis of the future predicted Head Motion information of a frame, which is five frames ahead thereof.

Further, the rendering unit 14 generates rendering information necessary for generating a saliency map representing the saliency of the predicted frame image 19 corresponding to the frame 15 (Step 106, same as above). In this embodiment, the depth map 21 shown in FIG. 5 and the motion vector map 22 shown in FIG. 6 are generated as the rendering information.

The saliency map generation unit 17 generates a saliency map corresponding to the frame 15 on the basis of the predicted frame image 19 and the rendering information (Step 107).

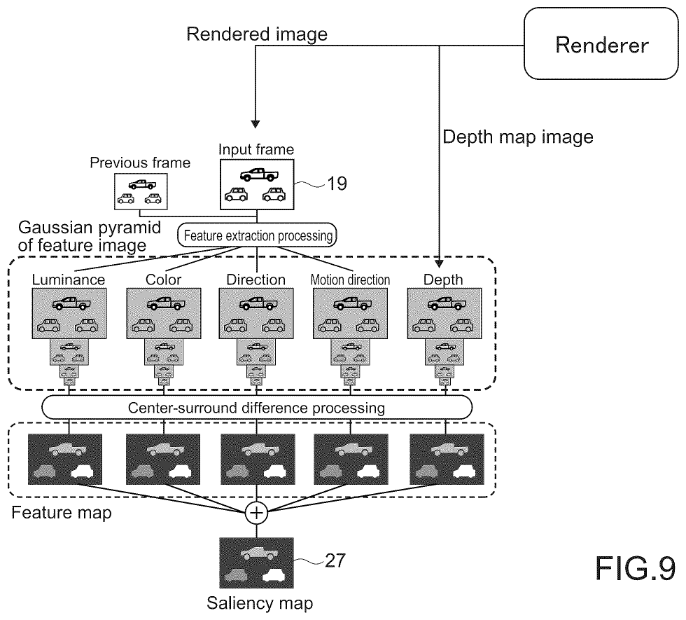

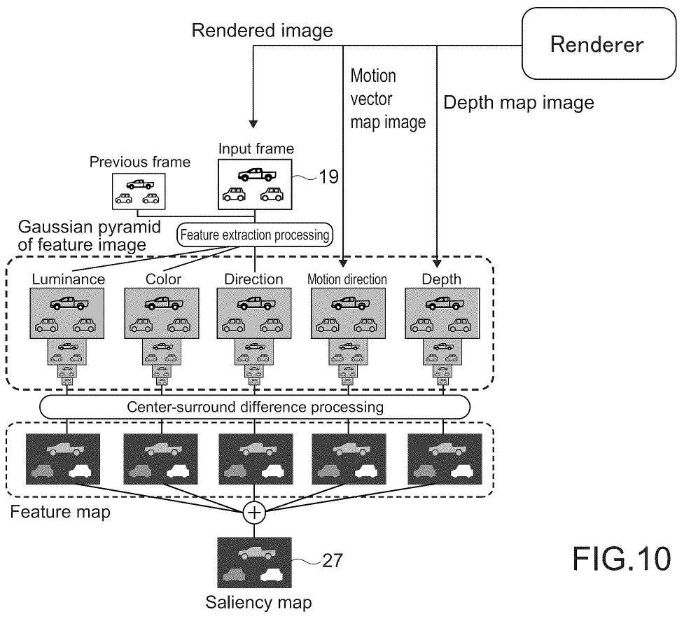

FIGS. 9 and 10 are schematic diagrams each showing an example of generating the saliency map.

In the example shown in FIG. 9, the predicted frame image 19 is input as an input frame.

Feature amount extraction processing is performed on the predicted frame image 19, and feature amounts of luminance, color, direction, and motion direction that attract bottom-up attention are extracted. Note that the predicted frame image 19 of the previous frame or the like may be used to extract the feature amounts.

For each feature amount of luminance, color, direction, and motion direction, a feature image in which the feature amount is converted into luminance is generated, and a Gaussian pyramid of the feature image is generated.

Further, the saliency map generation unit 17 acquires, as rendering information, the depth map image 21 shown in B of FIG. 5 from the renderer that constitutes the rendering unit 14. Such a depth map image 21 is used as a feature image of depth, and a Gaussian pyramid thereof is generated.

The Gaussian pyramids of the respective feature amounts are subjected to center-surround difference processing. As a result, feature maps are generated in the respective feature amounts of luminance, color, direction, motion direction, and depth. The feature maps of the respective feature amounts are integrated, so that a saliency map 27 is generated.

Specific algorithms of the feature amount extraction processing, the Gaussian pyramid generation processing, the center-surround difference processing, and the integration processing of the feature maps of the feature amounts are not limited. For example, each processing can be implemented using well-known techniques.

The depth map image 21 acquired from the renderer does not have a depth value estimated by performing a 2D image analysis or the like on the predicted frame image 19, but has a correct value obtained in the rendering step. In this regard, if the depth map image 21 is directly received from the renderer and used as feature information of “depth” to generate a saliency map 27, this makes it possible to generate a highly accurate and more precise saliency map 27.

In the example shown in FIG. 10, the saliency map generation unit 17 acquires, as rendering information, the motion vector map image 22 shown in B of FIG. 6 from the renderer that constitutes the rendering unit 14. Such a motion vector map image 22 is used as a feature image of motion direction, and a Gaussian pyramid thereof is generated.

The motion vector map image 22 acquired from the renderer does not have a value estimated by performing a 2D image analysis or the like on the predicted frame image 19, but has a correct value obtained in the rendering step. In this regard, if the depth map image 22 is directly received from the renderer and used as feature information of “movement direction” to generate a saliency map 27, this makes it possible to generate a highly accurate and more precise saliency map.

As described above, in the present technology, information regarding the saliency detection is acquired from the renderer that renders a 2D video (predicted frame image 19) viewed by the user 5, and a saliency map 27 is generated on the basis of the information.

The server-side rendering system 1 renders the 2D video viewed by the user 5 by itself, and thus it is configured to precisely acquire the information necessary to detect the saliency without analyzing a 2D video. The present technology takes advantage of this merit.

Note that, in the examples shown in FIGS. 9 and 10, two pieces of information of “depth” and information of “motion direction” are acquired as rendering information among the information of the visual feature amounts used for generating the saliency map 27. The present technology is not limited to this, and other feature amounts such as “luminance” and “color” can also be calculated in the rendering step and used as rendering information.

In other words, at least one of the luminance information of an object to be rendered or the color information of an object to be rendered may be used as a parameter regarding the rendering processing.

As a matter of course, the configuration in which only the motion vector map image 22 is used is also conceivable.

Any other algorithm may be used as the algorithm for generating the saliency map 27 on the basis of the predicted frame image 19 and the rendering information. For example, a machine learning model in which the predicted frame image 19 and the rendering information are input may be used, and the saliency map 27 may be generated by a machine-learning algorithm.

The generated saliency map 27 is recorded and held in the saliency map recording unit 18. As shown in FIG. 8, the saliency map 27 corresponding to the frame 15 is recorded in the 10th frame.

The encoding unit 15 encodes the predicted frame image 19. Further, the communication unit 16 transmits the encoded predicted frame image 19 to the client apparatus 3 (Step 108).

The predicted frame image 19 generated for the 10th frame is transmitted, as the first frame of the 6 DoF video content, to the HMD 2 via the client apparatus 3 and is displayed to the user 5. Thus, the distribution of the virtual video in which the influence of the response delay is sufficiently suppressed is started.

The rendering unit 14 determines whether or not the processing for all the frame images has been completed (Step 109). Here, as shown in FIG. 8, processing up to the frame 25 is to be executed.

Thus, the processing proceeds to No of Step 109 and returns to Step 102.

From the frame 11 to the frame 14 shown in FIG. 8, a processing flow in which the processing proceeds to No of Step 104 and proceeds from Step 105 to Step 106 is executed.

In the frame 15, there is a saliency map 27 corresponding to the frame 15, which is generated at the previous frame 10, as the saliency map 27 corresponding to the acquired “Head Motion information of a current time”. Accordingly, the processing proceeds to Yes of Step 104 and proceeds to Step 110.

In Step 110, the history information of the field-of-view information (Head Motion information) up to the current time and the saliency map 27 corresponding to the current time are input to predict future Head Motion information, which is generated as predicted Head Motion information.

A specific algorithm for generating the predicted Head Motion information by inputting the history information of the Head Motion information and the saliency map 27 is not limited, and any algorithm may be used. For example, any machine-learning algorithm may also be used.

Hereinafter, up to the frame 25, the processing proceeds to Yes of Step 104, and the saliency map 27 is used to generate predicted Head Motion information with high accuracy.

When the processing for all the frame images is completed, the processing proceeds to Yes of Step 109, and the video generation and distribution processing are terminated.

### [Generation of Saliency Map For Whole Sky]

If the omnidirectional video 6 (6 DoF video) as shown in FIG. 2 is distributed, generating a saliency map 27 for the whole sky makes it possible to further improve the prediction accuracy of the Head Motion prediction.

In this case, for example, in Step 106 of FIG. 7, not only the predicted frame image 19 corresponding to the field of view of the user but also a frame image for the whole sky are rendered on the basis of the predicted Head Motion information. In Step 107, a saliency map for the whole sky is then generated.

In Step 104, if there is a saliency map 27 for the whole sky corresponding to the “Head Motion information of a current time”, the processing proceeds to Step 110. The saliency map 27 for the whole sky is then used to generate predicted Head Motion information. This makes it possible to generate predicted Head Motion information with very high accuracy.

Note that the algorithm for generating the saliency map for the whole sky is not limited, and any algorithm may be used.

As described above, in the server-side rendering system 1 according to this embodiment, the server apparatus 4 generates the saliency map 27 representing the saliency of the two-dimensional video data on the basis of the parameters regarding the rendering processing for generating the two-dimensional video data, that is, the rendering information. This makes it possible to generate a highly accurate and more precise saliency map 27, and solve the above problem point (1).

Since the highly accurate and precise saliency map 27 is generated, it is possible to generate the predicted Head Motion information with very high accuracy, and it is possible to sufficiently suppress the problem of the response delay (T_m2pa time). In other words, it is possible to achieve high-quality virtual video distribution using the saliency map 27.

Note that the highly-accurate saliency map 27 generated in this embodiment can also be used for other use applications. For example, the saliency map 27 can also be used for line-of-sight prediction for the purpose of foveated rendering, high-efficiency encoding in which a large number of bit rates are allocated to a place having high saliency where a line of sight is concentrated in a screen, or the like. Thus, the distribution of the virtual video with higher quality is achieved.

### Second Embodiment

A server-side rendering system according to a second embodiment will be described.

In the following description, description of the configurations and effects similar to those in the server-side rendering system described in the above embodiment will be omitted or simplified.

In this embodiment, the scene description information (three-dimensional space description data) included in the three-dimensional space data is used for generating a saliency map 27. Specifically, the degree of importance of an object to be rendered is used.

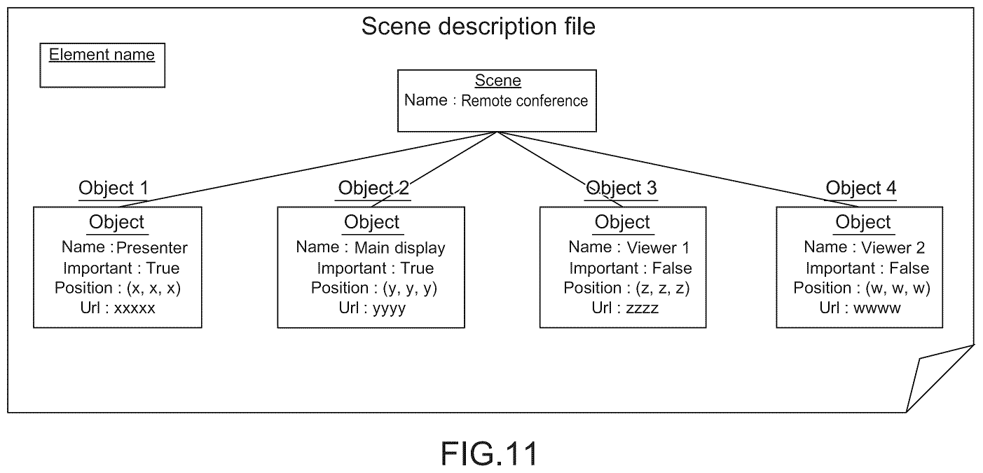

FIG. 11 is a schematic diagram showing a first example of information described in a scene description file, which is used as scene description information.

In this embodiment, when 6 DoF content is generated, information on whether or not an object is an important object in a scene is stored in each object information described in the scene description file.

In the example shown in FIG. 11, the following information is stored as object information.
Name . . . Name of object
Important . . . Degree of importance of object (True=Degree of importance 1/False=Degree of importance 0)
Position . . . Position of object
Url . . . Address of three-dimensional object data

In the example shown in FIG. 11, in a scene of a remote conference, two objects of a presenter and a main display that displays explanatory material are set as important objects in the scene (degree of importance 1), among the appearing objects.

On the other hand, a viewer 1 and a viewer 2 are not set as important objects (degree of importance 0).

Which object is set as an important object may be discretionally set. For example, in a scene in which a ball game is watched, a ball, a main player, or the like is set as an important object. Further, in a scene in which a theatrical performance or a concert is watched, an actor who is on a stage, a musician on a stage, or the like is set as an important object.

Any other settings may be employed.

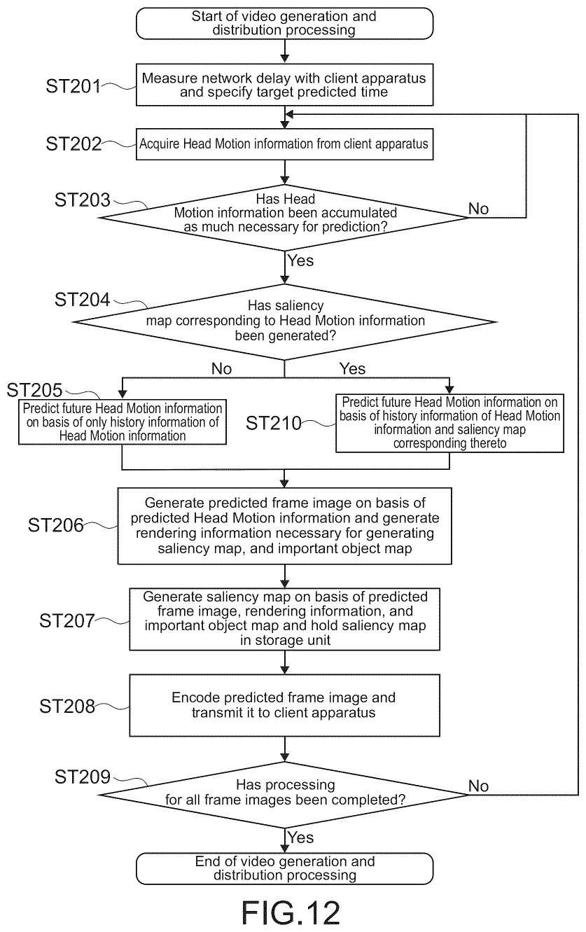

FIG. 12 is a flowchart showing an example of generation of a rendered video.

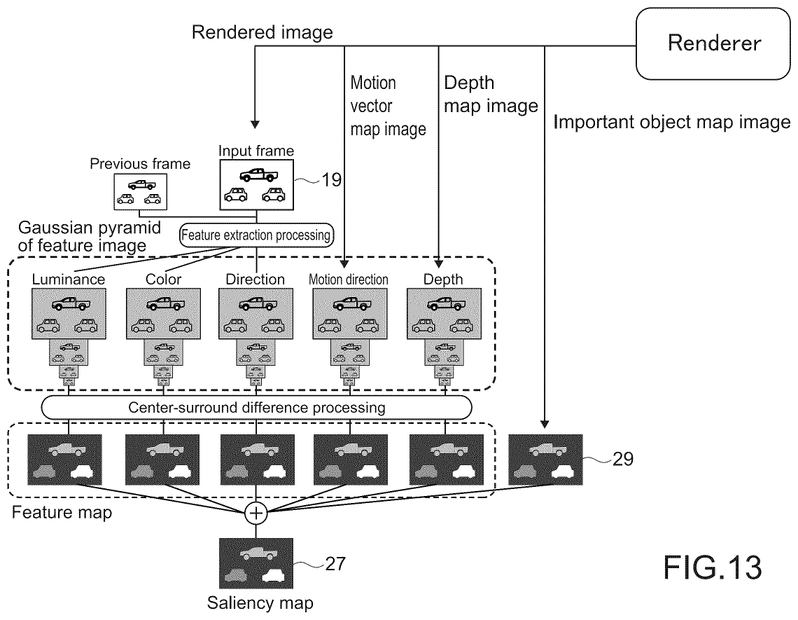

FIG. 13 is a schematic diagram showing an example of generation of a saliency map.

Steps 201 to 205 and 208 to 210 are similar to Steps 101 to 105 and 108 to 110 shown in FIG. 7.

In Step 206, the rendering unit 14 generates image data, which is obtained by converting the degree of importance (0 or 1) set for each object into luminance, as an important object map image 29. The important object map image 29 is data indicating a rendered portion of the important object.

In Step 307, as shown in FIG. 13, the important object map image 29 is integrated together with the feature maps of the respective feature amounts, and a saliency map 27 is generated. For example, a saliency map 27 is generated so as to apply a bias to the rendered portion of the important object. In addition, any method may be employed as the integration method.

As described above, in this embodiment, the saliency map 27 is generated on the basis of the degree of importance of the object. This makes it possible to reflect, in the saliency map 27, the top-down attention to the important object in each scene of the 6 DoF content, so that a highly accurate and more precise saliency map 27 can be generated. As a result, the above problem point (2) can be solved.

Note that a saliency map for the whole sky may also be generated.

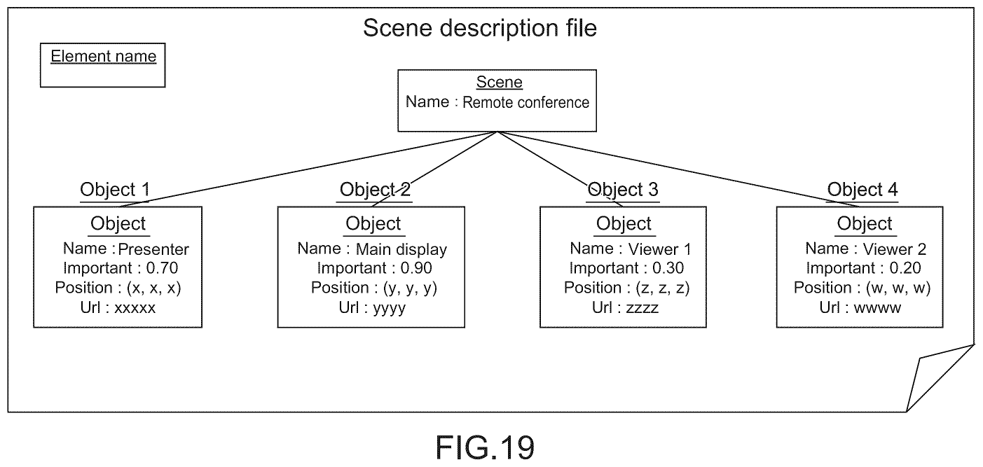

FIG. 19 is a schematic diagram showing a second example of the information described in the scene description file.

In the first example shown in FIG. 11, the degree of importance of each object is set as two values, “True (degree of importance 1)” or “False (degree of importance 0)”.

In contrast, in this second example, when 6 DoF content is generated, information indicating to what extent an object is important in the scene is stored in each object information described in the scene description file.

Specifically, as shown in FIG. 19, numerical values to the second decimal place included in the range from the minimum value 0.00 to the maximum value 1.00 are set as the degree of importance of each object. In other words, in the second example, the degree of importance of each object can be ranked in the range from the minimum value 0.00 to the maximum value 1.00.

This makes it possible to determine a relative ranking of the degree of importance of an object in a certain field of view, for example, and to generate a highly accurate and more suitable saliency map 27 in response to a change in the user's field of view.

In the example shown in FIG. 19, the following information is stored as object information.
Name . . . Name of object
Important . . . Degree of importance of object (numerical values between minimum value 0.00 to maximum value 1.00)
Position . . . Position of object
Url . . . Address of three-dimensional object data

In the example shown in FIG. 19, in a scene of a remote conference, the degree of importance of 0.70 is set for a presenter, and the degree of importance of 0.90 is set for a main display that displays explanatory material, among the appearing objects. Further, the degree of importance of 0.30 is set for a viewer 1, and the degree of importance of 0.20 is set for a viewer 2.

In other words, in the example shown in FIG. 19, a relatively high degree of importance is set for the two objects of the presenter and the main display that displays explanatory material. On the other hand, a relatively low degree of importance is set for the viewer 1 and the viewer 2.

For example, when the presenter and the viewer 1 fall within the user's field of view, the viewer 1 is an object with a relatively low degree of importance. On the other hand, when only the viewer 1 falls within the field of view, the viewer 1 has the highest degree of importance in the field of view.

In such a manner, according to the field of view of the user, it is possible to generate a more accurate saliency map 27 on the basis of the degree of importance of the object falling in the field of view.

As the method of setting the degree of importance, “True (degree of importance 1)” indicating that the object is an important object or “False (degree of importance 0)” indicating that the object is not an important object may be set for each object as in the first example shown in FIG. 11. The present technology is not limited to the above. The degree of importance may be ranked in the range from the minimum degree of importance to the maximum degree of importance for each object as in the second example shown in FIG. 19.

In the example shown in FIG. 19, the minimum degree of importance is determined as 0.00, the maximum degree of importance as 1.00, and numerical values from 0.00 to 1.00 are set for each object. The present technology is not limited to this, and the minimum degree of importance may be determined as 0, the maximum degree of importance as 100, and numerical values from 0 to 100 may be set for each object. In the second example shown in FIG. 19, it is possible to set the degree of importance in detail, and to generate a highly accurate saliency map 27.

In the example shown in FIG. 13, the depth map image 21 and the motion vector map image 22 serving as the rendering information are used to generate the saliency map 27. In other words, the saliency map 27 is generated on the basis of the rendering information and the scene description information (degree of importance).

The present technology is not limited to the above, and only the scene description information (degree of importance) may be used to generate the saliency map 27. In this case as well, it is possible to generate a saliency map in which top-down attention to an important object is reflected, and its effect is exerted.

### Third Embodiment

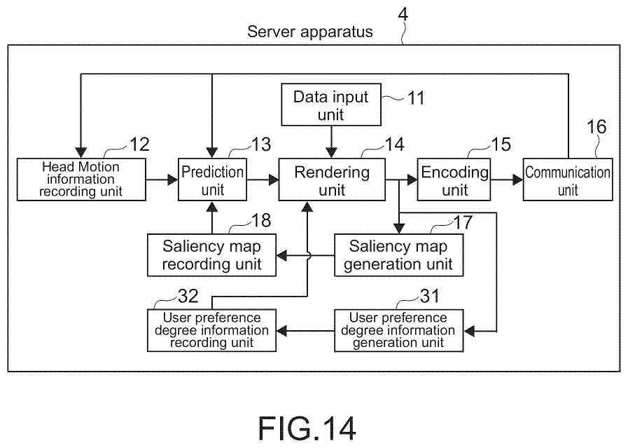

FIG. 14 is a schematic diagram showing a configuration example of a server-side rendering system according to a third embodiment.

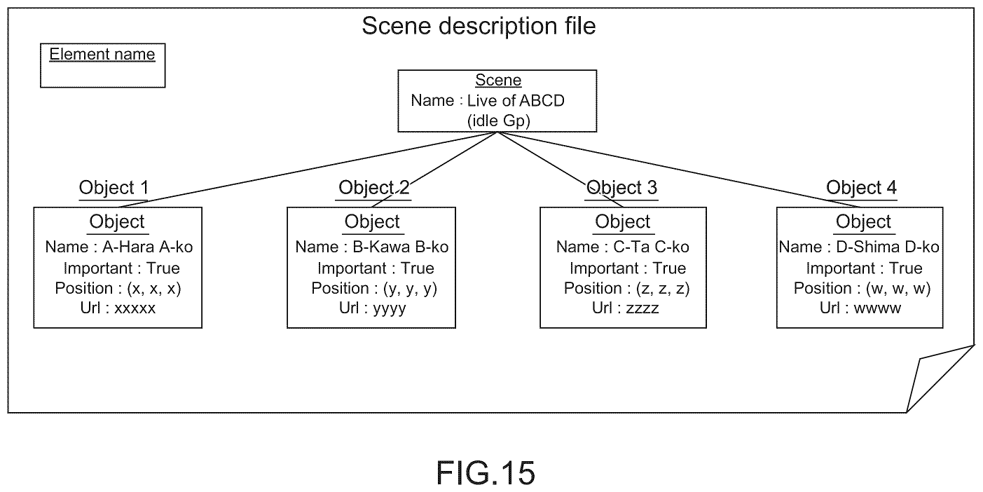

FIG. 15 is a schematic diagram showing an example of information described in a scene description file, which is used as scene description information.

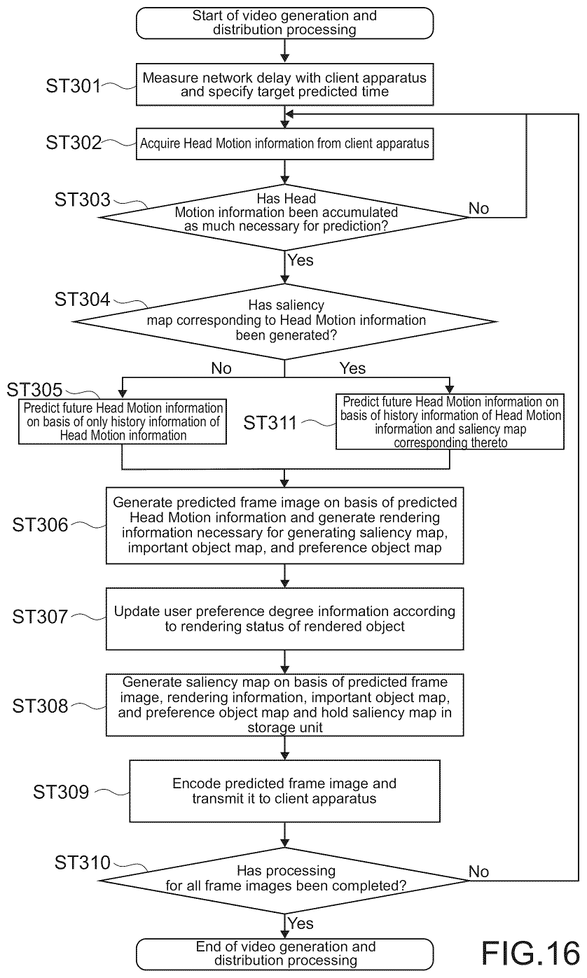

FIG. 16 is a flowchart showing an example of generation of a rendered video.

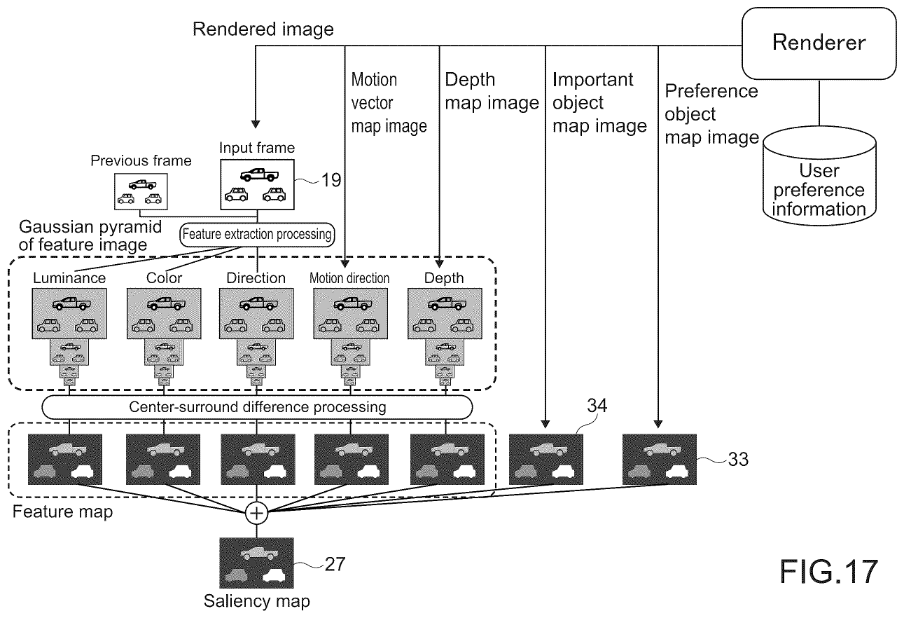

FIG. 17 is a schematic diagram showing an example of generation of a saliency map.

As shown in FIG. 14, in this embodiment, a user preference degree information generation unit 31 and a user preference degree information recording unit 32 are configured as functional blocks in the server apparatus 4. Those functional blocks are implemented by, for example, a CPU executing a program according to the present technology. In order to implement each functional block, dedicated hardware such as an integrated circuit (IC) may be appropriately used.

In this embodiment, the user preference degree information generation unit 31 functions as an embodiment of a calculation unit according to the present technology.

In this embodiment, when 6 DoF content is generated, identification information for uniquely identifying an object to be rendered is stored in each object information described in a scene description file.

As the identification information, for example, a name, a gender, an age, and the like are used. For example, when a celebrity such as an idle appears as a person object, the name, gender, age, and the like of the celebrity can be used as the identification information. As a matter of course, the identification information is not limited to the above and only needs to include at least one of any information capable of identifying the object. The fineness of the identification information makes it possible to identify the object in more detail.

In the example shown in FIG. 15, the following information is stored as object information.
Name . . . Name of object (Identification information)
Important . . . Degree of importance of object (True=Degree of importance 1/False=Degree of importance 0)
Position . . . Position of object
Url . . . Address of three-dimensional object data

In the example shown in FIG. 15, in a scene of a live concert of an idle group named ABCD, the names of four appearing idle objects (“A-Hara A-ko”, “B-Kawa B-ko”, “C-Ta C-ko”, and “D-Shima D-ko”) are stored as identification information. Further, since the four idles are main characters of the live concert, they are set as important objects (degree of importance 1).

The user preference degree information generation unit 31 calculates the degree of preference of the user on the basis of two-dimensional video data used by a user 5. In other words, the degree of preference of the user is calculated on the basis of the rendered video rendered by the rendering unit 14.

For example, the user 5 freely views the live video content of the idle ABCD by using the server-side rendering system 1. If the user 5 has a favorite idle, the user 5 is very likely to mainly view that person object many times.

Therefore, the user preference degree information generation unit 31 can determine the favorite idle of the user 5 depending on which person object is rendered many times (because the rendering unit 14 renders a video in the field of view that is viewed by the user 5).

For example, the number of times of rendering in the angle of view of the rendered video, that is, in the center portion of the viewport (display region), the size of the person object being rendered, and the like may be finely referred to as determination parameters. This makes it possible to exclude a situation, in which an object happens to be reflected on the end of the field of view of the user 5 many times, from the determination of the degree of preference, and possible to detect the preference of the user 5 with higher accuracy and calculate it as the degree of preference.

As described above, in this embodiment, the identification information of the object frequently rendered (frequently viewed by the user 5) is aggregated and managed as user preference degree information.

The calculated user preference degree information (degree of preference) is recorded in the storage unit 68 (see FIG. 18) by the user preference degree information recording unit 32. For example, a buffer or the like for recording user preference degree information may be configured. The recorded user preference degree information is output to the rendering unit 14.

In the flowchart shown in FIG. 16, Step 306 to Step 308 are different steps from the other embodiments described above.

In Step 306, the rendering unit 14 generates, as a preference object map image 33, image data obtained by converting the degree of preference calculated for each object into luminance. The preference object map image 33 is data indicating a rendered portion of an object that matches the preference of the user 5 and the degree of preference thereof.

Further, in Step 307, each time the rendering is executed, the user preference degree information generation unit 31 updates the user preference degree information according to a rendering status of the rendered object.

In Step 308, as shown in FIG. 17, the preference object map image 33 is integrated together with the feature maps of the respective feature amounts, and a saliency map 27 is generated. For example, a saliency map 27 is generated so as to apply a bias corresponding to the degree of preference to the rendered portion of the object that matches the preference of the user 5. In addition, any method may be employed as the integration method.

As described above, in this embodiment, the saliency map 27 is generated on the basis of the degree of preference with respect to the object. This makes it possible to reflect the top-down attention according to a personal preference of each user 5 in the saliency map, so that a highly accurate and more precise saliency map 27 can be generated. As a result, the above problem point (2) can be solved.

Note that a saliency map for the whole sky may be generated. Further, as the scene description information, information useful for estimating the preference of the user 5 may be stored in addition to the identification information.

### Other Embodiments

The present technology is not limited to the embodiments described above and can achieve various other embodiments.

The specific data structure (data format) of the scene description information is not limited, and any data structure may be used. Hereinafter, an example in which glTF (GL Transmission Format) is used as the scene description information will be described. In other words, a case where the data format of the scene description information is glTF will be described.

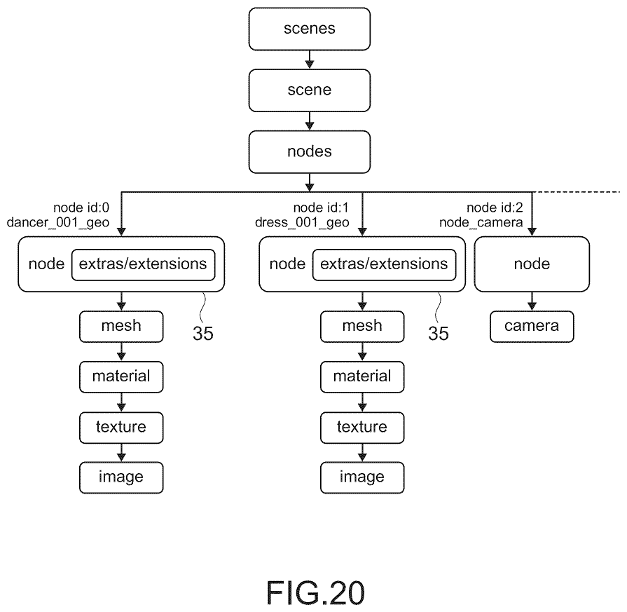

FIG. 20 is a schematic diagram showing a first example in which the degree of importance (degree-of-importance information) of each object is described when glTF is used as the scene description information.

In glTF, the relationship between components constituting scenes is represented by a tree structure. FIG. 20 shows a scene in which an object named dancer_001_geo and an object named dress_001_geo exist in the scene, the scene being configured with the intention to obtain a video of the scene, which is viewed from a viewpoint of a camera (named node_camera) placed at a certain position, by rendering.

The position of the camera designated by glTF is an initial position. The camera position is updated as needed by the field-of-view information transmitted from the HMD 2 to the client apparatus 3 from time to time or by the predicted field-of-view information, so that a rendered image corresponding to the position and direction of the HMD is generated.

Each object is shaped by mesh, and a color of a surface of the object is determined by an image (texture image) designated by referring to mesh, material, texture, and image in this order.

At that time, it is defined that the degree of importance of the object is given to a node (node) 35 that refers to mesh. This makes it possible to give the degree of importance to an object that has a shape in a scene and is visualized.

Note that the description of the position (x, y, z) of the object is omitted in FIG. 20, but the position can be described using a “Translation” field defined in glTF.

As shown in FIG. 20, in glTF, extension data can be stored in each node with an “extras” field and an “extensions” region being used as extended regions. In this example, a value of the degree of importance is stored in the extended region of the node 35 that refers to mesh. This makes it possible to give the degree of importance to each object.

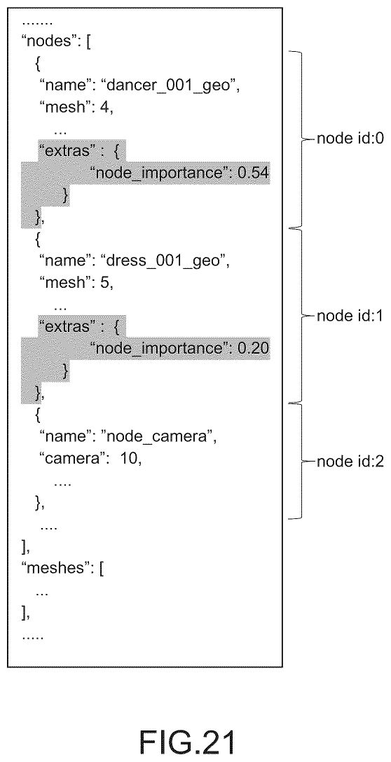

FIG. 21 is a schematic diagram showing a description example in glTF when the “extras” field defined by glTF is used as a method of giving the degree of importance to the node 35 that refers to mesh.

The name of a field in which a value of the degree of importance is stored is node_importance. The possible values are numerical values to the second decimal place included in the range from the minimum value 0.00 to the maximum value 1.00. 1.00 is a numerical value indicating that the degree of importance is highest, and 0.00 is a numerical value indicating that the degree of importance is lowest. Note that, when the value of the node_importance is multiplied by 100, the score value is from 0 to 100.

In the example shown in FIG. 21, the degree of importance of 0.54 is assigned to the object represented by the node named “dancer_001_geo”. Further, the degree of importance of 0.20 is assigned to the object represented by the node named “dress_001_geo”. Note that a node to which the degree of importance is not assigned, that is, a node in which the value of the degree of importance is not stored in the “extras” field, is regarded as having the degree of importance of 0.00.

There may be nodes with the same value of node_importance (degree of importance) in a scene. Further, a value of the highest degree of importance in a scene is not limited to 1.00 and may be a lower value. All of the setting, distribution, and the like of the value of the degree of importance may be set so as to depend on the intention of a content creator, for example.

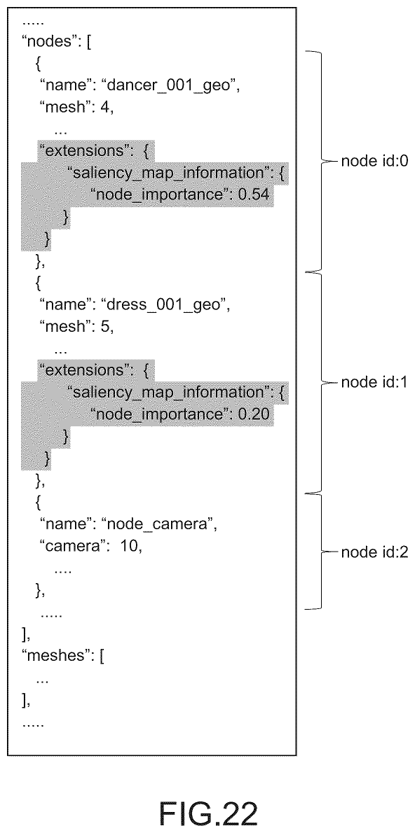

FIG. 22 is a schematic diagram showing a description example in glTF when the “extensions” region defined by glTF is used as a method of giving the degree of importance to the node 35 that refers to mesh.

The node_importance, in which the value of the degree of importance is stored, is placed in an extended field whose name is defined as saliency_map_information. The meaning of the node_importance is similar to the meaning of the node_importance stored in the “extras” described above.

In the example of FIG. 22, the degree of importance of 0.54 is assigned to the object represented by the node named “dancer_001_geo”. Further, the degree of importance of 0.20 is assigned to the object represented by the node named “dress_001_geo”.

As compared with the case of using the “extras” field as shown in FIG. 21, if the “extensions” region is used as shown in FIG. 22, a plurality of attribute values can be stored in a unique region having a unique name. Further, there is an advantage that processing can be performed by clearly distinguishing from other extension information by filtering using the name of an extended region as a key.

In the example shown in FIGS. 20 to 21, the node 35 that refers to mesh corresponds to an embodiment of a node corresponding to an object. Further, the example shown in FIGS. 20 to 21 corresponds to an embodiment in which the degree of importance is stored in an extended region of a node corresponding to an object.

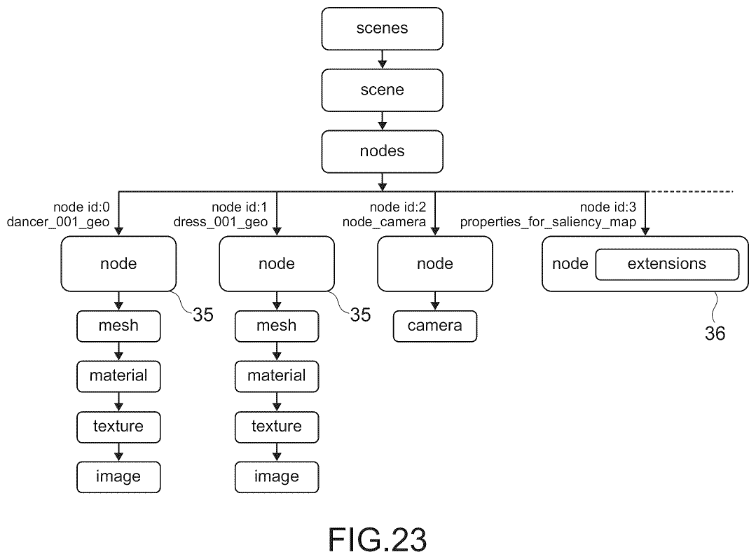

FIG. 23 is a schematic diagram showing a second example in which the degree of importance of each object is described when glTF is used as the scene description information.

In this second example, the values of the degree of importance of respective objects are stored together in an “extensions” region of an independent node 36. If an independent node 36 is prepared to store the values of the degree of importance of the respective objects, the degree of importance can be added without affecting the existing nodes (tree structure).

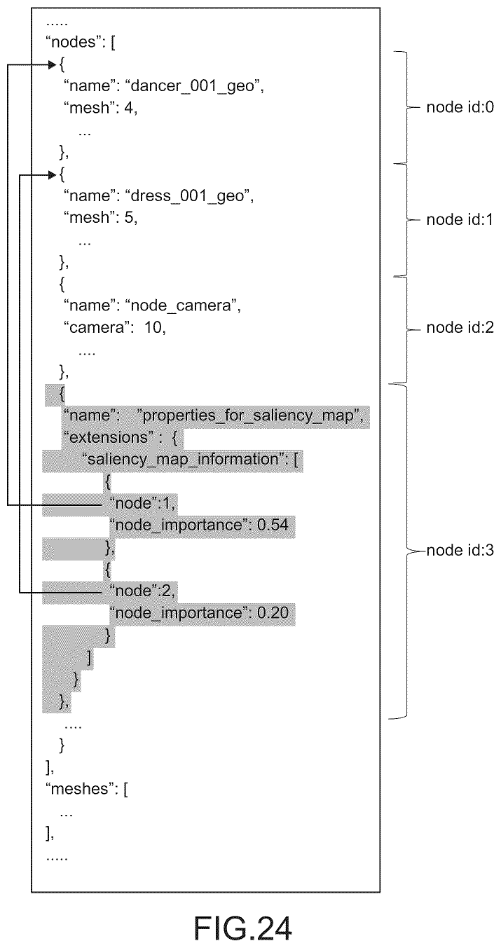

FIG. 24 is a schematic diagram showing a description example of glTF when the values of the degree of importance of the respective objects are stored in the “extensions” region of the independent node 36.

The name of the node 36 that stores the value of the degree of importance of an object is properties_for_saliency_map. Further, the name of the “extensions” region is saliency_map_information.

In saliency_map_information, a node field representing id of a node, to which the degree of importance is assigned, and node_importance, in which the value of the degree of importance is stored, are arranged as a pair. The meaning of node_importance is similar to the meaning of node_importance stored in the “extras” described above.

In the example shown in FIGS. 23 and 24, the independent node 36 corresponds to an embodiment of a node that is added to store the degree of importance of an object. Further, the example shown in FIGS. 23 and 24 corresponds to an embodiment of a case where the degree of importance of an object is stored, in association with the object, in an extended region of the node added to store the degree of importance of the object.

Note that, as a method of adding the degree of importance to an object On, the method of storing the degree of importance in the “extras” field of a node 35 that refers to mesh, the method of storing the degree of importance in the “extensions” region of a node 35 that refers to mesh, and the method of storing the degree of importance in association with each object On in the extended region of the independent node 36 may be used in any combination.

Further, the independent node 36 may be prepared for one object On, and the degree of importance of the object On may be stored in the “extras” field of the node 36.

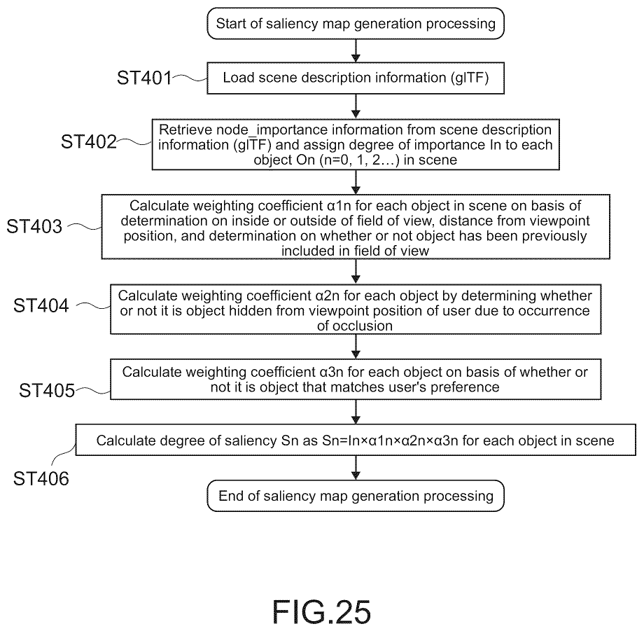

FIG. 25 is a flowchart showing a processing procedure of another example in which a saliency map 27 is generated from the scene description information (degree of importance). As described above, in this system, Head Motion information at a future time to be predicted (hereinafter, referred to as predicted future time) can be generated as predicted Head Motion information. A predicted frame image 19 is then generated on the basis of the predicted Head Motion information. Here, a saliency map 27 corresponding to the predicted frame image 19 is generated. Further, here, a case where a saliency map for the whole sky is generated will be described.

In Step 401, scene description information is loaded by the saliency map generation unit 17. Here, it is assumed that the scene description information is described in glTF.

In Step 402, node_importance information is retrieved from the scene description information (glTF), and a degree of importance In is assigned to each object On (n is an id that uniquely identifies an object in a scene and is the number starting from zero) in a scene.

In Step 403, a weighting coefficient α1n is calculated for each object On in the scene. In this embodiment, the coefficient α1n is calculated on the basis of a determination result of whether or not the object On is included in the field of view of the user, information of a distance to the object On, and a determination result of whether or not the object On has been previously included in the field of view of the user.

In this example, the coefficient α1n is set on the basis of whether the object On is in the field of view or out of the field of view, i.e., whether or not the object On is rendered in the predicted frame image 19. Further, the weighting coefficient α1n is calculated on the basis of the distance from the viewpoint position to the object On and whether or not the object has fallen within the field of view before the predicted future time.

It is possible to determine whether or not the object has fallen within the field of view before the predicted future time, for example, on the basis of a history of the field-of-view information before the predicted future time, a history of the predicted frame image 19 generated before the predicted future time, and the like.

In Step 403, first, a coefficient α1n of 1.00 is assigned to an object On located in a field of view of a user at the predicted future time, i.e., an object On rendered in the predicted frame image 19. 0.10 is assigned to an object On located outside the field of view.

Further, 0.20 is set for an object On that is located outside the field of view at the predicted future time but has fallen within the field of view even once before the predicted future time. Thus, in this example, the coefficient values are assigned to three types of objects On classified into: an object On located in the field of view; an object On located outside the field of view; and an object On that is located outside the field of view but has fallen within the field of view previously. This makes it possible to improve the accuracy of the saliency map 27.

Next, a coefficient corresponding to the distance from the viewpoint position of the user to the object On is integrated. In this example, the concept of a so-called level of details (LOD) is used in the determination of the coefficient. For example, 1.00 is integrated for an object On at a distance within 1 m from the viewpoint position of the user, 0.80 for an object On at a distance exceeding 1 m and equal to or smaller than 3 m, 0.70 for an object On at a distance exceeding 3 m and equal to or smaller than 10 m, and 0.50 for an object On at a distance exceeding 10 m. As a matter of course, the present technology is not limited to such level classification.

The result of integrating the coefficient corresponding to the distance to the object On is used again as the weighting coefficient α1n.

In Step 403, for example, a coefficient α1x of an object Ox, which is within the field of view at the predicted future time and has a distance of 2 m from the viewpoint, is α1x=1.00×0.80=0.80. A coefficient α1y of an object Oy, which is located behind the user at the predicted future time, that is, outside the field of view of the user, but has a distance of 4 m from the viewpoint and has once fallen within the field of view, is α1y=0.20×0.70=0.14.

In this example, the coefficient α1n is calculated on the basis of the three pieces of information (conditions) of: a determination result of whether or not the object On is included in the field of view of the user; information of a distance to the object On; and a determination result of whether or not the object On has been previously included in the field of view of the user.

The present technology is not limited to the above, and at least one of those three pieces of information may be used in the calculation. As a matter of course, a plurality of pieces of information selected from among those pieces of information may be used in any combination.

In other words, the coefficient α1n may be calculated on the basis of at least one of: a determination result of whether or not the object On is included in the field of view of the user; information of a distance to the object On; or a determination result of whether or not the object On has been previously included in the field of view of the user.

In Step 404, a weighting coefficient α2n is calculated for each object On in the scene. In this embodiment, the coefficient α2n is calculated on the basis of a situation in which occlusion occurs with respect to the object On by another object.

Note that the occlusion is a state in which an object located on the near side hides an object located behind, with the viewpoint position being a reference. The situation in which occlusion occurs includes, for example, information such as the presence or absence of occlusion occurrence and the extent to which an object is hidden by another object.

The situation in which occlusion occurs can be determined by using, for example, the Z buffer described above. Alternatively, simple pre-rendering may be performed to know the anteroposterior relationship of the object On, or a determination may be performed from a rendering result of a previous frame, for example.

In this example, the weighting coefficient α2n is calculated on the basis of a ratio of an area of the object On, which is seen without being hidden by another object, when the object On is viewed from the viewpoint of the user.

For example, if the object On is not hidden at all by another object and the whole of the object On is visible, the coefficient α2n=1.00. If the half of the object On is hidden by another object, the coefficient α2n=0.50. If the object On is completely hidden by another object and is not visible at all, the coefficient α2n=0.00.

Note that, for the object On that is outside the field of view at the future predicted time, the coefficient α2n is calculated on the basis of, for example, the situation in which occlusion occurs assuming that the user looks at the object On. The situation in which occlusion occurs assumed as descried above can be determined on the basis of the viewpoint position of the user, the position of each object On, and the like.

Alternatively, for the object On that is outside the field of view at the future predicted time, 1.00 may be set by default as the coefficient α2n, which means that the situation in which occlusion occurs is not considered. Note that, for the object On outside the field of view, a value equal to or lower than 0.20 is set for the weighting coefficient α1n in Step 403.

In Step 405, a weighting coefficient α3n is calculated for each object On in the scene. In this example, the coefficient α3n is calculated on the basis of the degree of preference of the user with respect to the object On.

In this example, it is determined whether or not each object On is an object that matches the user's preference. For an object On that matches the user's preference, the degree of preference of the user is set to be relatively high. For an object On that does not match the user's preference, the degree of preference of the user is set to be relatively low.

For example, in glTF or the like, detailed description and attribution information of each object On can be described in the scene description information. On the basis of the detailed description and the attribute information, it is possible to determine whether or not the object matches the user's preference, and it is possible to set the degree of preference of the user.

For example, in the user preference degree information generation unit 31 shown in FIG. 14, the degree of preference of the user with respect to each object On is calculated on the basis of the rendered video rendered by the rendering unit 14. As a matter of course, the degree of preference of the user can be used to calculate the coefficient α3n.

Further, the degree of preference of the user with respect to each object On may be calculated on the basis of the detailed description or the attribution information of each object On and the degree of preference calculated by the user preference degree information generation unit 31. For example, it is assumed that the user preference degree information generation unit 31 calculates the degree of preference with respect to a certain object A with a high value. If there is another object B having detailed description including a word deeply related to the object A, the other object B is determined as an object that matches the user's preference, and a high value is set as the degree of preference of the user. Such processing is also possible.

As a matter of course, the present technology is not limited thereto, and the degree of preference of the user with respect to each object On may be calculated by using any information capable of determining the preference of the user and the detailed description or attribution information of each object.

The coefficient α3n is set to a relatively high value for an object On that matches the user's preference, that is, for an object On having a high degree of preference of the user. For example, the coefficient α3n of the object On that appears to attract the user's interest is set to 1.00. The coefficient α3n of other objects On is set to 0.90.

This makes it possible to increase the degree of saliency of the object On that appears to attract the user's interest.

In Step 406, the degree of saliency Sn is calculated for each object On in the scene. The degree of saliency Sn is calculated as Sn=In×α1n×α2n×α3n from the coefficient group determined in the previous steps.

In the procedure described above, the degree of saliency Sn of each object On can be calculated on the basis of the degree of importance In of each object On in the scene, the position relationship of each object with respect to the viewpoint position of the user at the future predicted time, and the like.

A highly accurate saliency map 27 can be generated on the basis of the degree of saliency Sn calculated in Step 406.

In the example shown in FIG. 25, the weighting coefficient α1n corresponds to an embodiment of a first coefficient.

The weighting coefficient α2n corresponds to an embodiment of a second coefficient.

The weighting coefficient α3n corresponds to an embodiment of a third coefficient.

The calculation of Sn=In×α1n×α2n×α3n corresponds to one embodiment of each of: a result of integrating the first coefficient to the degree of importance; a result of integrating the second coefficient to the degree of importance; and a result of integrating the third coefficient to the degree of importance.

In the example shown in FIG. 25, the degree of saliency Sn is calculated as a result obtained by integrating each of the first to third coefficients to the degree of importance. The present technology is not limited to this, and only one of the first to third coefficients may be used. Alternatively, a plurality of coefficients discretionarily combined among the first to third coefficients may be used.

In other words, the degree of saliency Sn may be calculated using at least one of the first to third coefficients.

Further, the processing shown in FIG. 25 is also applicable to the case where the data format of the scene description information is a data format different from glTF.

In the above description, the case where the omnidirectional video 6 (6 DoF video) including 360-degree spatial video data or the like is distributed as a virtual image has been described as an example. The present technology is not limited to the above and is also applicable to a case where a 3 DoF video, a 2D video, or the like is distributed. Further, as the virtual image, an AR video or the like may be distributed instead of the VR video.

Further, the present technology is also applicable to a stereo video (for example, a right-eye image, a left-eye image, and the like) for viewing a 3D video.

FIG. 18 is a block diagram showing a hardware configuration example of a computer (information processing apparatus) 60 that can provide the server apparatus 4 and the client apparatus 3.

The computer 60 includes a CPU 61, a read only memory (ROM) 62, a RAM 63, an input/output interface 65, and a bus 64 that connects those components to each other. A display unit 66, an input unit 67, a storage unit 68, a communication unit 69, a drive unit 70, and the like are connected to the input/output interface 65.

The display unit 66 is, for example, a display device using liquid crystal, electro-luminescence (EL), or the like. The input unit 67 is, for example, a keyboard, a pointing device, a touch panel, or another operation device. If the input unit 67 includes a touch panel, the touch panel may be integrated with the display unit 66.

The storage unit 68 is a nonvolatile storage device and is, for example, an HDD, a flash memory, or another solid-state memory. The drive unit 70 is, for example, a device capable of driving a removable recording medium 71 such as an optical recording medium or a magnetic recording tape.

The communication unit 69 is a modem, a router, or another communication device that can be connected to a LAN, a WAN, or the like for communicating with other devices. The communication unit 69 may communicate using wires or radios. The communication unit 69 is often used separately from the computer 60.

The information processing by the computer 60 having the hardware configuration as described above is implemented in cooperation with the software stored in the storage unit 68, the ROM 62, or the like and the hardware resource of the computer 60. Specifically, the information processing method according to the present technology is implemented when a program configuring the software, which is stored in the ROM 62 or the like, is loaded into the RAM 63 and then executed.

The program is installed in the computer 60, for example, through the recording medium 61. Alternatively, the program may be installed in the computer 60 via a global network or the like. In addition, any non-transitory computer-readable storage medium may be used.

The information processing method and the program according to the present technology may be executed, and the information processing apparatus according to the present technology may be provided, by linking a plurality of computers communicably connected via a network or the like.

In other words, the information processing method and the program according to the present technology can be performed not only in a computer system formed of a single computer, but also in a computer system in which a plurality of computers operates cooperatively.

Note that, in the present disclosure, the system refers to a set of components (such as apparatuses and modules (parts)) and it does not matter whether all of the components are in a single housing. Thus, a plurality of apparatuses accommodated in separate housings and connected to each other through a network, and a single apparatus in which a plurality of modules is accommodated in a single housing are both the system.

Execution of the information processing method and the program according to the present technology by the computer system includes, for example, both a case in which the acquisition of the field-of-view information, the execution of the rendering processing, the generation of the saliency map, the generation of the rendering information, the acquisition of the degree of importance of the object, the generation of the user preference degree information, and the like are performed by a single computer; and a case in which the respective processes are performed by different computers. Further, the execution of each process by a predetermined computer includes causing another computer to perform part or all of the processes and obtaining a result thereof.

In other words, the information processing method and the program according to the present technology are also applicable to a configuration of cloud computing in which a single function is shared and cooperatively processed by a plurality of apparatuses through a network.

The configurations of the server-side rendering system, the HMD, the server apparatus, the client apparatus, and the like described with reference to the respective figures; and the processing flows thereof; and the like are merely embodiments, and any modifications may be made thereto without departing from the spirit of the present technology. In other words, any other configurations or algorithms for purpose of practicing the present technology may be employed.

In the present disclosure, to easily understand the description, the words such as “substantially”, “approximately”, and “about” are appropriately used. Meanwhile, it does not define a clear difference between the case where those words such as “substantially”, “approximately”, and “about” are used and the case where those words are not used.

In other words, in the present disclosure, concepts defining shapes, sizes, positional relationships, states, and the like, such as “central”, “middle”, “uniform”, “equal”, “same”, “orthogonal”, “parallel”, “symmetric”, “extended”, “axial”, “columnar”, “cylindrical”, “ring-shaped”, and “annular”, are concepts including “substantially central”, “substantially middle”, “substantially uniform”, “substantially equal”, “substantially the same”, “substantially orthogonal”, “substantially parallel”, “substantially symmetric”, “substantially extended”, “substantially axial”, “substantially columnar”, “substantially cylindrical”, “substantially ring-shaped”, “substantially annular”, and the like.

For example, the states included in a predetermined range (e.g., range of ±10%) with reference to “completely central”, “completely middle”, “completely uniform”, “completely equal”, “completely the same”, “completely orthogonal”, “completely parallel”, “completely symmetric”, “completely extended”, “completely axial”, “completely columnar”, “completely cylindrical”, “completely ring-shaped”, “completely annular”, and the like are also included.

Therefore, even if the words such as “substantially”, “approximately”, and “about” are not added, the concept that may be expressed by adding so-called “substantially”, “approximately”, and “about” thereto can be included. To the contrary, the complete states are not necessarily excluded from the states expressed by adding “substantially”, “approximately”, “about”, and the like.

In the present disclosure, expressions using the term “than” such as “greater than A” and “less than A” are expressions that comprehensively include concepts that include the case of being equal to A and concepts that do not include the case of being equal to A. For example, “greater than A” is not limited to the case where it does not include “equal to A”; however, it also includes “equal to or greater than A”. Further, “less than A” is not limited to “less than A”; it also includes “equal to or less than A”.

Upon implementation of the present technology, specific settings and other settings may be appropriately adopted from the concepts that are included in “greater than A” and “less than A” to achieve the effects described above.

At least two of the features among the features described above according to the present technology can also be combined. In other words, various features described in the respective embodiments may be combined discretionarily regardless of the embodiments. Further, the various effects described above are merely illustrative and not restrictive, and other effects may be exerted.

Note that the present technology may also take the following configurations.
(1) An information processing apparatus, including:
   a rendering unit that performs rendering processing on three-dimensional space data on the basis of field-of-view information regarding a field of view of a user, to generate two-dimensional video data corresponding to the field of view of the user; and
   a generation unit that generates a saliency map representing a saliency of the two-dimensional video data on the basis of a parameter regarding the rendering processing.
(2) The information processing apparatus according to (1), further including
   a prediction unit that generates the field-of-view information in a future as predicted field-of-view information on the basis of the saliency map, in which
   the rendering unit generates the two-dimensional video data on the basis of the predicted field-of-view information.
(3) The information processing apparatus according to (2), in which
   the field-of-view information includes at least one of a viewpoint position, a line-of-sight direction, a rotational angle of a line of sight, a head position of the user, or a rotational angle of a head of the user.
(4) The information processing apparatus according to (3), in which
   the field-of-view information includes the rotational angle of the head of the user, and
   the prediction unit predicts a future rotational angle of the head of the user on the basis of the saliency map.
(5) The information processing apparatus according to any one of (2) to (4), in which
   the two-dimensional video data is configured by a plurality of frame images consecutive in time series, and
   the rendering unit generates a frame image on the basis of the predicted field-of-view information and outputs the frame image as a predicted frame image.
(6) The information processing apparatus according to any one of (2) to (5), in which
   the prediction unit generates the predicted field-of-view information on the basis of history information of the field-of-view information and the saliency map.
(7) The information processing apparatus according to (6), further including
   an acquisition unit that acquires the field-of-view information in real time, in which
   the prediction unit generates the predicted field-of-view information on the basis of history information of the field-of-view information to a current time and the saliency map representing a saliency of the predicted frame image corresponding to the current time.
(8) The information processing apparatus according to (7), in which
   the prediction unit generates, if the saliency map representing the saliency of the predicted frame image corresponding to the current time is not generated, the predicted field-of-view information on the basis of the history information of the field-of-view information to the current time.
(9) The information processing apparatus according to any one of (1) to (8), in which
   the rendering unit generates the parameter regarding the rendering processing on the basis of the three-dimensional space data and the field-of-view information.
(10) The information processing apparatus according to (9), in which
   the parameter regarding the rendering processing includes at least one of information of a distance to an object to be rendered or motion information of an object to be rendered.
(11) The information processing apparatus according to (9) or (10), in which
   the parameter regarding the rendering processing includes at least one of luminance information of an object to be rendered or color information of an object to be rendered.
(12) The information processing apparatus according to any one of (1) to (11), in which
   the three-dimensional space data includes three-dimensional space description data that defines a configuration of a three-dimensional space, and three-dimensional object data that defines a three-dimensional object in the three-dimensional space, and
   the generation unit generates the saliency map on the basis of the parameter regarding the rendering processing and the three-dimensional space description data.
(13) The information processing apparatus according to (12), in which
   the three-dimensional space description data includes a degree of importance of an object to be rendered.
(14) The information processing apparatus according to (13), in which
   the generation unit calculates a first coefficient on the basis of at least one of a determination result of whether or not the object is included in the field of view of the user, information of a distance to the object, or a determination result of whether or not the object has been previously included in the field of view of the user, and generates the saliency map on the basis of a result of integrating the first coefficient to the degree of importance.
(15) The information processing apparatus according to (14), in which
   the generation unit calculates a second coefficient on the basis of a situation in which occlusion occurs with respect to the object by another object, and generates the saliency map on the basis of a result of integrating the second coefficient to the degree of importance.
(16) The information processing apparatus according to (15), in which
   a third coefficient is calculated on the basis of a degree of preference of the user with respect to the object, and the saliency map is generated on the basis of a result of integrating the third coefficient to the degree of importance.
(17) The information processing apparatus according to any one of (12) to (16), in which
   the three-dimensional space description data includes identification information for identifying an object to be rendered,
   the information processing apparatus further includes a calculation unit that calculates a degree of preference of the user with respect to the object on the basis of the identification information, and
   the generation unit generates the saliency map on the basis of the parameter regarding the rendering processing and the degree of preference of the user.
(18) The information processing apparatus according to any one of (12) to (17), in which
   a data format of the three-dimensional space description data is glTF (GL Transmission Format).
(19) The information processing apparatus according to (18), in which
   the three-dimensional space description data includes a degree of importance of an object to be rendered, and
   the degree of importance is stored in an extended region of a node corresponding to the object, or is stored in an extended region of a node added to store the degree of importance of the object in association with the object.
(20) An information processing method, which is executed by a computer system, the information processing method including:
   performing rendering processing on three-dimensional space data on the basis of field-of-view information regarding a field of view of a user, to generate two-dimensional video data corresponding to the field of view of the user; and
   generating a saliency map representing a saliency of the two-dimensional video data on the basis of a parameter regarding the rendering processing.
(21) The information processing apparatus according to (17), in which
   the identification information includes at least one of a name, a gender, or an age.
(22) The information processing apparatus according to (17) or (21), in which
   the calculation unit calculates the degree of preference on the basis of a history of the two-dimensional video data viewed by the user.
(23) The information processing apparatus according to any one of (1) to (22), in which
   the three-dimensional space data includes at least one of omnidirectional video data or spatial video data.

### REFERENCE SIGNS LIST

1 server-side rendering system
2 HMD
3 client apparatus
4 server apparatus
5 user
6 omnidirectional video
8 rendered video
13 prediction unit
14 rendering unit
15 encoding unit
16 communication unit
17 saliency map generation unit
19 predicted frame image
21 depth map image
22 vector map image
27 saliency map
29 important object map image
31 user preference degree information generation unit
33 preference object map image
35 node referring to mesh
36 independent node added to store degree of importance
60 computer

1. An information processing apparatus, comprising:
a rendering unit that performs rendering processing on three-dimensional space data on a basis of field-of-view information regarding a field of view of a user, to generate two-dimensional video data corresponding to the field of view of the user; and
a generation unit that generates a saliency map representing a saliency of the two-dimensional video data on a basis of a parameter regarding the rendering processing.

2. The information processing apparatus according to claim 1, further comprising
a prediction unit that generates the field-of-view information in a future as predicted field-of-view information on a basis of the saliency map, wherein
the rendering unit generates the two-dimensional video data on a basis of the predicted field-of-view information.

3. The information processing apparatus according to claim 2, wherein
the field-of-view information includes at least one of a viewpoint position, a line-of-sight direction, a rotational angle of a line of sight, a head position of the user, or a rotational angle of a head of the user.

4. The information processing apparatus according to claim 3, wherein
the field-of-view information includes the rotational angle of the head of the user, and
the prediction unit predicts a future rotational angle of the head of the user on a basis of the saliency map.

5. The information processing apparatus according to claim 2, wherein
the two-dimensional video data is configured by a plurality of frame images consecutive in time series, and
the rendering unit generates a frame image on a basis of the predicted field-of-view information and outputs the frame image as a predicted frame image.

6. The information processing apparatus according to claim 2, wherein
the prediction unit generates the predicted field-of-view information on a basis of history information of the field-of-view information and the saliency map.

7. The information processing apparatus according to claim 6, further comprising
an acquisition unit that acquires the field-of-view information in real time, wherein
the prediction unit generates the predicted field-of-view information on a basis of history information of the field-of-view information to a current time and the saliency map representing a saliency of the predicted frame image corresponding to the current time.

8. The information processing apparatus according to claim 7, wherein
the prediction unit generates, if the saliency map representing the saliency of the predicted frame image corresponding to the current time is not generated, the predicted field-of-view information on a basis of the history information of the field-of-view information to the current time.

9. The information processing apparatus according to claim 1, wherein
the rendering unit generates the parameter regarding the rendering processing on a basis of the three-dimensional space data and the field-of-view information.

10. The information processing apparatus according to claim 9, wherein
the parameter regarding the rendering processing includes at least one of information of a distance to an object to be rendered or motion information of an object to be rendered.

11. The information processing apparatus according to claim 9, wherein
the parameter regarding the rendering processing includes at least one of luminance information of an object to be rendered or color information of an object to be rendered.

12. The information processing apparatus according to claim 1, wherein
the three-dimensional space data includes three-dimensional space description data that defines a configuration of a three-dimensional space, and three-dimensional object data that defines a three-dimensional object in the three-dimensional space, and
the generation unit generates the saliency map on a basis of the parameter regarding the rendering processing and the three-dimensional space description data.

13. The information processing apparatus according to claim 12, wherein
the three-dimensional space description data includes a degree of importance of an object to be rendered.

14. The information processing apparatus according to claim 13, wherein
the generation unit calculates a first coefficient on a basis of at least one of a determination result of whether or not the object is included in the field of view of the user, information of a distance to the object, or a determination result of whether or not the object has been previously included in the field of view of the user, and generates the saliency map on a basis of a result of integrating the first coefficient to the degree of importance.

15. The information processing apparatus according to claim 14, wherein
the generation unit calculates a second coefficient on a basis of a situation in which occlusion occurs with respect to the object by another object, and generates the saliency map on a basis of a result of integrating the second coefficient to the degree of importance.

16. The information processing apparatus according to claim 15, wherein
a third coefficient is calculated on a basis of a degree of preference of the user with respect to the object, and the saliency map is generated on a basis of a result of integrating the third coefficient to the degree of importance.

17. The information processing apparatus according to claim 12, wherein
the three-dimensional space description data includes identification information for identifying an object to be rendered,
the information processing apparatus further comprises a calculation unit that calculates a degree of preference of the user with respect to the object on a basis of the identification information, and
the generation unit generates the saliency map on a basis of the parameter regarding the rendering processing and the degree of preference of the user.

18. The information processing apparatus according to claim 12, wherein
a data format of the three-dimensional space description data is glTF (GL Transmission Format).

19. The information processing apparatus according to claim 18, wherein
the three-dimensional space description data includes a degree of importance of an object to be rendered, and
the degree of importance is stored in an extended region of a node corresponding to the object, or is stored in an extended region of a node added to store the degree of importance of the object in association with the object.

20. An information processing method, which is executed by a computer system, the information processing method comprising:
performing rendering processing on three-dimensional space data on a basis of field-of-view information regarding a field of view of a user, to generate two-dimensional video data corresponding to the field of view of the user; and
generating a saliency map representing a saliency of the two-dimensional video data on a basis of a parameter regarding the rendering processing.
